(19) United States
(12) Patent Application Publication
(10) Pub. No.: US 2025/0059007 A1
(43) Pub. Date: Feb. 20, 2025

(54) A SELF-CLIMBING TOWER CRANE

(71) Applicant: Itrec B.V., SCHIEDAM (NL)

(72) Inventor: Diederick Bernardus WIJNING, SCHIEDAM (NL)

(73) Assignee: Itrec B.V., SCHIEDAM (NL)

(21) Appl. No.: 18/722,029

(22) PCT Filed: Dec. 21, 2022
(86) PCT No.: PCT/EP2022/087324

§ 371 Date: Jun. 20, 2024

(30) Foreign Application Priority Data
Dec. 21, 2021 (NL) 2030208
Apr. 12, 2022 (NL) 2031556

(51) Int. Cl. B66C 23/28; B66C 23/20; B66C 23/34; F03D 13/10

(52) U.S. Cl. CPC B66C 23/283; B66C 23/207; B66C 23/344; F03D 13/10; F05B 2230/61

(57) ABSTRACT

A self-climbing tower crane includes a crane base configured to be placed on a support at a hoisting site, tower segments to erect a crane tower, a crane tower lifting unit mounted on the crane base, and a slewable jib unit. The tower crane is configured to, with the slewable jib unit connected to an upper tower segment, erect the crane tower by stacking tower segments onto one another from below to lengthen the crane tower under the slewable jib unit. The crane tower includes an upper section to be composed of a series of multiple upper tower segments and a lower section to be composed of a series of multiple lower tower segments. Each upper tower segment is embodied as a tubular girder type tower segment. Each lower tower segment is embodied as a latticed structure type tower segment. The tower crane further includes an upper stabilizer device and a lower stabilizer device, each configured to horizontally connect the upper section of the crane tower to an external tall structure, e.g. a wind turbine mast.

### FIELD OF THE INVENTION

The present invention relates to the field of self-climbing tower cranes. In particular, the invention concerns the use of such a tower crane in the field of wind turbines, e.g. when assembling a wind turbine, installation or de-installing a wind turbine rotor blade, etc.

### BACKGROUND OF THE INVENTION

In the field of wind turbine installation and maintenance it is known to make use of a self-climbing tower crane. Generally such a crane comprises:
a crane base configured to the placed on the support at the hoisting site,
a crane tower to be erected on the crane base and to be composed of tower segments that are to be stacked one-by-one onto one another,
a crane tower lifting unit configured to perform a lifting action in the process of erecting the crane tower,
a slewable jib unit configured to be mounted on top of the crane tower.

For example, the Liebherr 1000 EC-B 125 Litronic Tower Crane has been used to erect a wind turbine having a hub height of 149 m and a rotor diameter of 115 m. This crane has a 31.50 m jib and provides a hook height of 164 m, with a hoisting capacity of 100 tonnes.

A key factor in the deployment of cranes at the location of a wind turbine is the footprint. Often a so-called hardstand is often prepared close to the foundation of the wind turbine to allow for stable placement of the tower crane. Sometimes the crane base is secured directly to the (concrete) foundation of the wind turbine.

The Liebherr crane is erected by a method that starts with an initiation phase wherein a sizable auxiliary crawler crane is used to assemble the tower crane to an initial hook height of 39 m. From this point the self-climbing crane tower assembly phase takes place, wherein the crane tower is further erected by stacking tower segments one-by-one on top of one another to lengthen the crane tower under the jib unit. Herein the crane tower lifting unit is located directly underneath the jib unit and performs a lifting action each time a tower segment has been stacked. The crane tower segments are generally embodied as latticed steel segments having main chords at the corners with a square horizontal cross-section, in the case of the Liebherr crane of 3.40 m×3.40 m with a length of 5.80 m. The jib of the Liebherr crane is of the non-luffing type, with a trolley that travels over the horizontal jib. The crane hoisting cable(s) depend from the trolley and extend to one or more winches of the slewable jib unit. The Liebherr jib has a counter ballast jib section provided with a counter ballast. This known crane has at least one external stabilizer device configured to horizontally connect the crane tower to the wind turbine mast.

Another known self-climbing tower crane for use in the field of wind turbine installation is disclosed in EP3434639 of S&L Access Systems AB. Herein the crane tower lifting unit is mounted on the crane base and remains at said location. In practice, the initiation phase of this known tower crane involves the use of one or more sizable auxiliary cranes to assemble the tower crane to an initial hook height. From this point the crane tower assembly phase takes place, wherein the crane tower is erected by stacking tower segments one-by-one from below to lengthen the crane tower under the jib unit. Herein the crane tower lifting unit performs a lifting action each time a tower segment has been stacked underneath the already assembled part of the crane tower. This known tower crane has multiple external stabilizer devices, each configured to horizontally connect the crane tower to the wind turbine mast.

During hoisting operations, the very tall and vertically oriented crane tower is subject to significant loads thereon, such as bending stresses and torsional loads, e.g. when hoisting a wind turbine blade.

### OBJECT OF THE INVENTION

According to a first aspect thereof, the invention aims to provide an improved self-climbing tower crane, in particular in view of absorbing the loads acting on the crane tower. In embodiments, the first aspect of the invention also seeks to reduce potential damage to the external tall structure, in particular to a coating on a wind turbine mast. In embodiments, the first aspect of the invention also seeks to reduce time and/or efforts for assembly of the tower crane at the hoisting site, the space required at the hoisting site, the transportation of the components of the tower crane, etc.

### SUMMARY OF THE INVENTION

The first aspect of the invention provides a self-climbing tower crane that is configured to be arranged on a support at a hoisting site, e.g. at a foot of a wind turbine mast, wherein the tower crane comprises:
a crane base configured to be placed on the support at the hoisting site,
tower segments which are configured to be stacked onto one another from below in order to erect a crane tower which is composed of the tower segments on the crane base,
a crane tower lifting unit mounted on the crane base and configured to perform lifting actions in the process of stacking of the tower segments, wherein the crane tower lifting unit stepwise lifts the crane tower from below,
a slewable jib unit configured to be mounted on top of the crane tower,
wherein the tower crane is configured to—with the slewable jib unit connected to an upper tower segment—erect the crane tower by stacking tower segments onto one another from below to lengthen the crane tower under the slewable jib unit.

According to the first aspect of the invention, the crane tower comprises an upper section to be composed of a series of multiple upper tower segments and a lower section to be composed of a series of multiple lower tower segments, the lower section being configured to support the upper section thereon,
wherein each upper tower segment is embodied as a tubular girder type tower segment having a height and having an outer peripheral wall of steel plate, as well as upper and lower end portions provided with connectors to rigidly interconnect the upper tower segments,
wherein each lower tower segment embodied as a latticed structure type tower segment having a height, having a main chord at each corner, and bracing between adjacent main chords, wherein the main chords are provided at ends thereof with connectors to rigidly interconnect the lower tower segments,
wherein the tower crane further comprises an upper stabilizer device and a lower stabilizer device, each configured to horizontally connect the upper section of the crane tower to an external tall structure, e.g. a wind turbine mast.

Due to this design of the crane tower an optimal stability and load absorption of the crane tower can be achieved at an attractive weight of the crane tower, e.g. compared to the known designs wherein the crane tower is completely composed of lattice structure type tower segments. Also, undue loads on the stabilizer devices and of the stabilizer devices onto the external tall structure, e.g. the wind turbine mast, can be avoided. For example, when the upper and lower stabilizer devices are configured to engage on a wind turbine mast, which is commonly of circular cross-section, and is configured to frictionally engage on the wind turbine mast, e.g. these stabilizer devices each being provided with a mast encircling assembly which is configured to frictionally engage on the mast, damage to the wind turbine mast, e.g. to a coating thereof, due to too much stress can be avoided. In case the upper section would also be of a latticed structure, the upper section is much more likely to deform under load, which unduly increases loads on these stabilizer devices and on the external tall structure. By having the lower section of a latticed design, weight is saved which benefits factors like vertical load of the crane on the support, transportation, as well as total wind load on the crane, etc.

The upper section of the crane tower effectively forms a lengthy and sturdy vertical oriented box structure which distributes the crane loads over the upper and lower stabilizer devices that connect the upper section to the external structure, e.g. the wind turbine mast. These loads include torsional loads acting about a vertical axis on the crane tower. For example, the loads are due to the jib and the object that is hoisted being offset from the vertical axis of the crane tower, and/or due to slew motions of the jib unit, wind forces acting on the load (e.g. on a wind turbine blade that is hoisted).

In embodiments, the outer peripheral wall of steel plate is, preferably internally, reinforced by steel longitudinal stiffeners extending along the height of the peripheral wall, e.g. forming reinforcement columns along the inside of the outer peripheral wall.

In embodiments, the outer peripheral wall of the upper segments is of a rectangular, preferably square, horizontal cross-section. Other possible, less preferred, cross-sections are for example, circular, oval, hexagonal, etc.

In embodiments, one or more steel diaphragm plates are present, preferably horizontally, inside each upper tower segment, e.g. halfway of the height and/or at other heights within the upper segment, e.g. at both ends of the upper segment. A diaphragm plate can have a central hole, e.g. to save weight and/or to allow (electrical) cables to pass through.

In practical embodiments, the crane tower can have a height of at least 100 meters.

In practical embodiments, the crane tower extends from the support at the foot of a wind turbine mast over the entire height of the wind turbine mast, preferably extending upwardly beyond the top of the mast, e.g. even beyond a top side of a nacelle mounted on the mast top.

In embodiments, each upper tower segment has a height of at least 6 meters, e.g. between 8 and 12 meters, e.g. 10.8 meters. For example, it is envisaged that each upper tower segment is to be transported to the hoisting site on a 40 ft. ISO flatbed container, e.g. the container having end members between which the upper segment is horizontally secured for transport, e.g. on a road vehicle.

In embodiments, the height of the upper section is at least 10%, preferably at least 20%, and at most 50% of the height of the crane tower when in use at a hoisting site.

In embodiments, e.g. in the field of wind turbine installation, e.g. when installing a wind turbine blade, the height of the upper section is at least 25 meters, e.g. between 40 and 60 meters.

In embodiments, the upper section is composed of between three and six upper segments, e.g. each having a height between 8 and 12 meters.

In embodiments, the upper and lower stabilizer devices are configured to be in torque absorbing engagement with the upper section of the crane tower at an upper level and lower level, respectively.

In embodiments, when in use at a hoisting site adjacent a wind turbine mast, the upper section extends upward beyond the top end of the wind turbine mast, e.g. upward beyond a nacelle placed on top of the wind turbine mast.

Preferably, when in use at a hoisting site adjacent a wind turbine mast, the upper section is connected via the upper stabilizer device to a location in proximity of the top end of the wind turbine mast and via the lower stabilizer device located at the lower end of the upper section. This allows for a maximum vertical height difference between the two stabilizer devices that stabilize the upper section relative to the wind turbine mast. For example, in practical embodiments, this vertical spacing is at least 20 meters, e.g. when the crane is in use adjacent a wind turbine mast.

In embodiments, yet not preferred, the crane comprises at least a third stabilizer device that is configured and use to stabilize the lower section of the crane tower relative to the tall external structure.

In embodiments, at least the upper stabilizer device is configured to travel up and down along the upper section. Preferably, each of the lower and upper stabilizer devices is configured to travel up and down along the upper section.

In embodiments, the upper tower segments are each provided with at least one guide rail, e.g. at least one pair of guide rails, extending along the height of the upper tower segment such that guide rails of the interconnected upper tower segments form a substantially continuous guide rail, wherein at least the upper stabilizer device is configured to travel up and down along the continuous guide rail of the upper section. Preferably, each of the lower and upper stabilizer devices is configured to travel up and down along the continuous guide rail of the upper section.

For example, the upper tower segments are square in horizontal cross-section, wherein at least one pair of guide rails is provided on each upper segment, each guide rail being present at a respective corner of the upper segment.

As will be explained herein, the ability of one or both of the upper and lower stabilizer devices to travel up and down relative to the upper section of the tower crane is highly beneficial during the erecting of the crane tower.

In an embodiment, each of the lower and upper stabilizer devices is configured to travel up and down along the continuous guide rail of the upper section is provided with a locking device configured to lock the stabilizer at a selected height onto the upper section.

In embodiments, at least the lower stabilizer device is configured to travel up and down along the lower section of the crane tower. For example, the lower section is then composed of lower segments having a relevant cross-section corresponding to that of the upper segments so that the lower stabilizer device can travel over both the lower and upper section. For example, the lower segments have a guide rail that is continuous with the guide rail of the upper section.

In embodiments—also in accordance with the second aspect of the invention—the crane, preferably the jib unit, is provided with an upper stabilizer hoist device configured to hoist the upper stabilizer device along the upper section.

Preferably, the upper stabilizer hoist device is configured to provide a constant lift force mode allowing to suspend the upper stabilizer from the hoist device with a constant lift force. This allows for the upper stabilizer device to be stationary relative to the external tall structure whilst the crane tower is extended from below, thereby support at least part of the weight of the upper stabilizer.

For example, the upper stabilizer hoist device comprises a winch mounted on the jib unit, e.g. having a constant tension mode.

In embodiments, the crane is further provided with a tagline system, e.g. with one or more tagline rails or guide wires extending along the height of the crane for tagline trolleys. One or more taglines are then provided that can connect, for example, to the blade lifting tool that is used in hoisting a wind turbine blade. For example, one or more taglines rails are present on the crane tower segments.

In embodiments, the lower and upper stabilizers are configured to engage on a wind turbine mast, e.g. wherein the lower and upper stabilizers each comprise a mast encircling assembly configured to encircle a mast,

In embodiments, the lower and upper stabilizers are configured to frictionally engage on a wind turbine mast, e.g. the mast encircling assembly being configured to frictionally engage on the mast.

In embodiments, the upper segments and the lifting unit are configured such that the upper segments are to be lifted by the crane tower lifting unit when assembling the upper section of the crane tower. Then the lower segments are added from below using the lifting unit to assemble the lower section underneath the upper section of the crane tower.

In embodiments, the lower segments are individual, fixed height lower segments, as is known in the art.

In another embodiments, also according to the third aspect of the present invention, multiple of the lower tower segments, e.g. all of the lower tower segments, are embodied as telescopic latticed tower segment assemblies, each assembly being composed of an outer lower tower segment and an inner lower tower segment which is slidably mounted in the outer lower tower segment between a retracted position and an extended position,
wherein each of the inner and outer lower tower segments is embodied as a latticed structure type lower tower segment having a height, having a main chord at each corner, and bracing between adjacent main chords,
wherein the inner and outer lower tower segment are provided with cooperating locking members configured to lock the inner lower tower segment in the extended position thereof relative to the outer lower tower segment, and wherein the inner lower tower segment is provided with connectors to connect the inner lower tower segment to an outer lower tower segment of another telescopic latticed tower segment assembly, and wherein the outer lower tower segment is provided with connectors to connect the outer lower tower segment to an inner lower tower segment of another telescopic latticed tower segment assembly.

The provision of telescopic latticed tower segment assemblies allows for a reduction of transport requirements when transporting the components of the crane to the hoisting site, as well as for onsite space for storage of the components. Also, in embodiments, erecting the crane can be accelerated compared to the use of the well-known individual, fixed height lower segments.

When telescopic latticed tower segment assemblies are provided, in an embodiment, also multiple adapter members are provided in the crane tower lower section, each adapter member having at one of the upper and the lower side thereof connectors configured to mate with connectors of an outer tower segment and at the other one of the of the upper and the lower side thereof connectors configured to mate with connectors of an inner tower segment.

In embodiments—also in accordance with the fourth aspect of the invention—the crane tower lifting unit is pivotally mounted to the crane base so as to be pivotal between a horizontal and vertical orientation, and wherein a first upper segment is arranged in the crane tower lifting unit, and wherein the crane base and crane tower lifting unit mounted thereon with the first upper segment arranged therein form a first transportable assembly, e.g. configured for road transportation, e.g. the crane base being embodied as a trailer of a first road vehicle or to be loaded on a trailer of a first road vehicle, and wherein the slewable jib unit forms a second transportable assembly, e.g. configured for road transportation, e.g. the slewable jib unit being embodied to be loaded on a trailer of a second road vehicle,. Herein, with the first transportable assembly arranged at the hoisting site, the slewable jib unit is connectable to the upper segment whilst the crane tower lifting unit is oriented horizontally. The interconnected crane tower lifting unit and slewable jib unit are then pivotal relative to the crane base into a vertical orientation of at least the crane tower lifting unit in an upending step. Due to this design and approach, the initial installation phase of the crane can be performed more efficient, e.g. quicker, than in the mentioned prior art designs, and/or the size of the hardstand on which the crane can be reduced. In particular, in embodiments, this design avoids or reduces the need for personnel to perform assembly steps at great height during this phase of the crane construction.

In embodiments, the slewable jib unit comprises:
a slew bearing mounted between a lower jib unit structure that is to be connected to the crane tower and an upper jib unit structure,
a jib that is pivotally mounted to the upper jib unit structure about a jib pivot axis,
a jib luffing mechanism configured to luff the jib, and
a winch and associated hoisting cable depending from a sheave assembly on the jib.

Preferably, when the jib unit is transported to the site and connected to the first upper segment the jib is oriented horizontally, directed with its outer end away from the also horizontal lifting unit. During making of the connection to the upper tower segment, the jib preferably remains horizontal. During the upending step, in embodiments, the jib is pivoted downwards whilst the lifting unit is pivoted towards the vertical orientation. For example, at an intermediate point of the upending step, the jib is substantially perpendicular to the main axis of the lifting unit. Then, in embodiments, the jib can be locked in its angular position relative to the lifting unit, e.g. by a temporary sling being arranged between a hook of the jib unit and the lifting unit. An auxiliary crane may assist in the upending step. For example, the auxiliary crane first lifts the interconnected lifting unit and jib unit near their point of interconnection. And, possibly, in a second phase of the upending step, the auxiliary crane is then used to lift the outer end of the jib, thereby moving the lifting unit into its vertical orientation.

The first aspect of the invention also relates to a method for installing or de-installing of a wind turbine component, e.g. a wind turbine blade, a nacelle component, etc., wherein use is made of a tower crane as described herein.

The first aspect of the invention also relates to a method for construction of a wind turbine mast, wherein use is made of a tower crane as described herein.

The first aspect of the invention also relates to a method for erecting a self-climbing tower crane on a support at a hoisting site, e.g. adjacent a wind turbine mast, wherein use is made of a tower crane as described herein, and wherein:
the first transportable assembly is arranged at the hoisting site,
wherein the slewable jib unit is connected to the first upper tower segment whilst the crane tower lifting unit with the first upper tower segment is oriented horizontally,
wherein, in an upending step, e.g. involving the use of an auxiliary crane, the interconnected crane tower lifting unit and slewable jib unit are pivoted relative to the crane base into a vertical orientation of the tower lifting unit,
wherein the method further comprises a crane tower assembly phase, in which—with the interconnected crane tower lifting unit in vertical orientation—the crane tower is erected by first stacking one or more additional upper tower segments one-by-one underneath the first upper tower segment to form the upper section of the crane tower and then stacking lower tower segments one-by-one underneath the upper section to form the lower section of the crane tower, in which crane tower assembly phase the crane tower lifting unit performs lifting actions in association with the stacking of tower segments.

The first aspect of the invention also relates to a self-climbing tower crane comprises a crane base configured to be placed on a support at a hoisting site, tower segments to erect a crane tower, a crane tower lifting unit mounted on the crane base, and a slewable jib unit. The tower crane is configured to, with the slewable jib unit connected to an upper tower segment, erect the crane tower by stacking tower segments onto one another from below to lengthen the crane tower under the slewable jib unit. The crane tower comprises an upper section to be composed of a series of multiple upper tower segments and a lower section to be composed of a series of multiple lower tower segments. Each upper tower segment is embodied as a tubular girder type tower segment. Each lower tower segment is embodied as a latticed structure type tower segment. The tower crane further comprises an upper external stabilizer device and a lower stabilizer device, each configured to horizontally connect the upper section of the crane tower to an external tall structure, e.g. a wind turbine mast.

The second aspect of the present invention relates to a self-climbing tower crane that is configured to be arranged on a support at a hoisting site, wherein the tower crane comprises:
a crane base configured to be placed on the support at the hoisting site,
a crane tower to be erected on the crane base and to be composed of tower segments that are to be stacked onto one another from below,
a crane tower lifting unit configured to perform lifting actions in the process of stacking of tower segments from below,
a slewable jib unit configured to be mounted on top of the crane tower,
wherein the tower crane is configured to—with the slewable jib unit connected to an upper tower segment—erect the crane tower by stacking tower segments onto one another from below to lengthen the crane tower under the slewable jib unit,
wherein the tower crane further comprises at least an upper stabilizer device, optionally also a lower stabilizer device, each configured to horizontally connect the crane tower to an external tall structure, e.g. a wind turbine mast.

According to the second aspect of the invention, the tower crane, for example the jib unit, is provided with a hoist device configured to hoist the upper stabilizer device along the crane tower, e.g. along the upper tower section in an embodiment of the tower crane according to the first aspect of the invention.

Preferably, the hoist device is configured to provide a constant lift force mode allowing to suspend the upper stabilizer from the hoist device with a constant lift force allowing for the upper stabilizer to be stationary relative to the tall external structure whilst the crane tower is extended thereby support at least part of the weight of the upper stabilizer.

For example, the upper stabilizer hoist device comprises a winch, e.g. mounted on the jib unit, e.g. having a constant tension mode.

In embodiments, the upper stabilizer, and optionally lower stabilizer, is/are configured to engage on a wind turbine mast, e.g. wherein the lower and/or upper stabilizers each comprise a mast encircling assembly configured to encircle a mast.

In embodiments, the lower and/or upper stabilizers are configured to frictionally engage on a wind turbine mast, e.g. the mast encircling assembly being configured to frictionally engage on the mast.

The second aspect of the invention also relates to a method for erecting the tower crane of the second aspect, wherein during an extension of the crane tower by addition of a tower segment from below and lifting the crane tower by means of the lifting unit the upper stabilizer hoist device is in a constant tension mode thereof, e.g. so as to effectively suspend the upper stabilizer from the hoist device whilst remaining stationary relative to the tall external structure, e.g. the wind turbine mast, e.g. whilst frictionally clamping the wind turbine mast.

The third aspect of the invention relates to a self-climbing tower crane that is configured to be arranged on a support at a hoisting site, wherein the tower crane comprises:
a crane base configured to be placed on the support at the hoisting site,
a crane tower to be erected on the crane base and to be composed of tower segments that are to be stacked onto one another, e.g. from below,
a crane tower lifting unit configured to perform lifting actions in the process of stacking of tower segment, e.g. from below,
a slewable jib unit configured to be mounted on top of the crane tower,
wherein the tower crane is, preferably, configured to—with the slewable jib unit connected to an upper tower segment—erect the crane tower by stacking tower segments onto one another to lengthen the crane tower under the slewable jib unit.

According to the third aspect of the invention multiple of the tower segments are embodied as telescopic latticed tower segment assemblies, each composed of an outer tower segment and an inner tower segment which is slidably mounted in the outer tower segment between a retracted position and an extended position,
wherein each of the inner and outer tower segments is embodied as a latticed structure type tower segment having a height, having a main chord at each corner, and bracing between adjacent main chords,
wherein the inner and outer segment are provided with locking members configured to lock the inner tower segment in the extended position thereof relative to the outer segment, and wherein the inner tower segment is provided with connectors to connect the inner tower segment to an outer segment of another telescopic latticed tower segment assembly, and wherein the outer tower segment is provided with connectors to connect the outer tower segment to an inner segment of another telescopic latticed tower segment assembly.

In an embodiment, the crane tower is provided with multiple adapter members having at one of the upper and the lower side thereof connectors configured to mate with connectors of an outer tower segment and at the other one of the of the upper and the lower side thereof connectors configured to mate with connectors of an inner tower segment.

The third aspect of the invention also relates to a method for erecting the tower crane, wherein the assemblies are transported to the site in a configuration wherein the inner segment is retracted inside the outer segment. For example, such an assembly is configured to be transported on a 40 ft. flatbed ISO container. For example, the assembly is extended while being handled by the crane tower lifting unit.

The fourth aspect of the present invention aims to provide a more efficient self-climbing tower crane, in particular in view of the initiation phase and/or in view of the size of the stabile support, often called hardstand, at the hoisting site for the crane that is needed in said phase.

The fourth aspect of the invention provides for a method for erecting a self-climbing tower crane on a support at a hoisting site, wherein the crane comprises:
a crane base configured to the placed on the support at the hoisting site,
a crane tower to be erected on the crane base and to be composed of tower segments that are to be stacked one-by-one onto one another,
a crane tower lifting unit configured to perform a lifting action in the process of erecting the crane tower,
a slewable jib unit configured to be mounted on top of the crane tower,
wherein the method comprises an arranging step, wherein an assembly is arranged at the hoisting site in an initiation state thereof, the assembly in said initiation state comprising:
   the crane base placed on the support at the hoisting site,
   the crane tower lifting unit pivotally mounted to the crane base and oriented horizontally,
   the slewable jib unit connected to the crane tower lifting unit and oriented horizontally,
wherein the method comprises an upending step wherein the interconnected crane tower lifting unit and slewable jib unit are pivoted relative to the crane base into a vertical orientation,
wherein the method comprises a crane tower assembly phase, wherein—with the interconnected crane tower lifting unit and slewable jib unit in said vertical orientation—the crane tower is erected by stacking tower segments one-by-one onto one another to lengthen the crane tower under the jib unit, wherein the crane tower lifting unit performs a lifting action in association with the stacking of a tower segment.

Due to the inventive approach, the initiation phase can be performed more efficient, e.g. quicker, than in the mentioned prior art designs, and/or the size of the hardstand can be reduced.

In embodiments of the invention it is possible to avoid the use of a (sizable) auxiliary crane. In other embodiments, an auxiliary crane, e.g. a mobile telescopic boom crane, is employed for erecting the tower crane.

For example, as preferred, in any aspect of the invention, the tower crane is configured to hoist at load of at least 100 tonnes.

For example, as preferred, in any aspect of the invention, the jib has a length of at least 10 meters, e.g. between 12 and 18 meters.

For example, in any aspect of the invention, the hoisting cable depends from a sheave assembly at the tip end of the jib.

In a practical embodiment, the assembly in the initiation state also comprises at least one tower crane segment that is retained by the lifting unit, wherein the slewable jib unit is connected to the crane tower lifting unit via this at least one tower crane segment.

Preferably, the at least one tower crane segment is retained such that the jib unit is as close as possible to the lifting unit in this initiation state in view of the subsequent upending step and the moment loads on the interconnected lifting unit and jib unit, as well as other components loaded in the upending process.

In a preferred embodiment of any aspect of the invention, the lifting unit remains stationary and connected to the crane base in the crane tower assembly phase, with the crane tower being lengthened in upward direction from the lifting unit. As the lifting unit is likely to be subject to significant bending moment load during the upending step, this stationary arrangement of the lifting unit allows for a sturdy design of the lifting unit.

In a practical embodiment of any aspect of the invention, the lifting unit comprises a lifting unit frame having an open top and an open bottom for successive passage of crane tower segments upward through the lifting unit from below when erecting the crane tower. The lifting unit further comprises a lifting actuator mechanism, e.g. comprising hydraulic cylinders and/or winch(es), configured and operated to perform a stepwise lifting of the crane tower. The lifting unit further comprises a locking mechanism to lock the crane tower at appropriate moments in the lifting process.

In embodiments of any aspect of the invention, after completion of the upending step when present, one or more stabilizing frame members are arranged between the crane base and the upended lifting unit.

In an embodiment, the assembly that is arranged at the hoisting site in an initiation state thereof further comprises a pivoting actuator mechanism that is configured and operated in the upending step to pivot the interconnected crane tower lifting unit and slewable jib unit in said vertical orientation. For example, use is made of a pivotal upending frame that is pivotally mounted to the crane base at one end and has a free outer end. A winch driven cable pull mechanism is provided between the free outer end of the upending frame and the crane base. The outer end of the frame is secured via one or more tensile members to the lifting unit so that upon exerting a pull force by means of the pull mechanism, the interconnected lifting unit and jib unit are upended. In another embodiment, one or more hydraulic cylinders are provided as pivoting actuator mechanism, mounted between the crane base and the lifting unit.

In another embodiment of any aspect of the invention, an auxiliary crane is used for the upending step, when present. For example, the upending step is a multi-stage, e.g. two stage, process, e.g. as discussed herein.

In an embodiment of any aspect of the invention, the method comprises:
the use of a first road vehicle to transport the crane base and the crane tower lifting unit pivotally mounted to the crane base and oriented horizontally to the hoisting site,
the use of a second road vehicle to transport the slewable jib unit oriented horizontally to the hoisting site,
wherein the arranging step comprises manoeuvring the second road vehicle in alignment with the horizontally oriented crane tower lifting unit and connecting the slewable jib unit to the crane tower lifting unit. The connecting step may involve the use of an auxiliary crane to hoist the slewable jib unit from the second vehicle and to support the jib unit as it is connected to the tower segment in the lifting unit, preferably whilst the jib of the jib unit is horizontal with the outer end thereof directed away from the lifting unit of the crane.

In an embodiment, no use is made of an auxiliary crane for hoisting the jib unit from the second vehicle. Instead, the jib unit is off-loaded from the second vehicle via the upending step, e.g. a first stage thereof, so in unison with the lifting unit, without requiring intermediate handling (.e.g. by an auxiliary crane) of the jib unit.

The transportation of the jib unit to the hoisting site by means of a second road vehicle may, in any aspect of the invention, allow for a significant size and/or hoisting capacity of the jib unit. For example, the second road vehicle has a trailer chassis on which the jib unit is loaded, e.g. the trailer chassis being embodied as a low flatbed trailer, on which the jib unit is loaded with the jib, preferably the entire jib, in horizontal orientation. For example, the jib is a rigid, non-telescoping jib, having a length of at least 10 meters.

In a preferred embodiment of any aspect of the invention, the first road vehicle forms at least a part of the crane base. In a method, the first road vehicle is parked on the support, e.g. the hardstand, at the hoisting site and the serves as (part of) the crane base. For example, the first road vehicle has a chassis, e.g. a trailer chassis, e.g. like a low flatbed trailer, that forms at least a part of the crane base. For example, the first road vehicle is provided with deployable support struts to stabilize the road vehicle on the support.

In an embodiment of any aspect of the invention, the second road vehicle also forms a part of the crane base, so remains at the hoisting site. For example, each of the first and second road vehicle have a chassis, e.g. a trailer chassis, e.g. a low flatbed trailer chassis, that forms a part of the crane base. Preferably, the arranging step then comprises mechanically interconnecting the chassis of the first and second road vehicle to form a rigid component of the crane base. The latter allows to obtain a large and stabile crane base, e.g. in view of the upending of the interconnected lifting unit and jib unit. In another embodiment of any aspect of the invention, only the first road vehicle forms part of the crane base, with the second road vehicle being moved away.

In an embodiment of any aspect of the invention, the slewable jib unit comprises a slew bearing mounted between a lower jib unit structure that is to be connected to the crane tower or the crane tower lifting unit and an upper jib unit structure, a jib that is pivotally mounted to the upper jib unit structure about a jib pivot axis, a jib luffing mechanism configured to luff the jib, a winch and associated hoisting cable depending from a sheave assembly on the jib. For example, one or more hydraulic cylinders are part of the jib luffing mechanism.

As preferred, in any aspect of the invention, the jib of the jib unit is substantially horizontal when transported to the hoisting site, e.g. on a trailer, e.g. with the lower jib unit structure being directed to the rear of the road vehicle.

In a practical embodiment of any aspect of the invention, the jib unit is operated to handle the tower segments in the crane tower assembly phase, e.g. the jib unit being operated to lift the tower segment from a road vehicle. In another embodiment of any aspect of the invention, an auxiliary crane is used for handling tower segments in this phase.

In a practical embodiment of any aspect of the invention, the first road vehicle is provided with a tower segment handling device that is movable between a first position underneath the vertically oriented lifting unit and a second position remote from the first position. In embodiments, a new tower segment is placed vertically on the tower segment handling device in the second position and then shifted by means of the tower segment handling device to the first position. In the first position the new tower segment is connected to the already assembled portion of the crane tower. Then the lifting unit is operated to perform a lifting action wherein the crane tower and the jib unit are lifted, so that a further new tower segment can be stacked underneath the crane tower. This process is repeated until the crane tower is high enough.

The fourth aspect of the present invention also relates to a self-climbing tower crane that is configured to be arranged on a support at a hoisting site, wherein the tower crane comprises:
a crane base configured to be placed on the support at the hoisting site,
a crane tower to be erected on the crane base and to be composed of tower segments that are to be stacked one-by-one onto one another,
a crane tower lifting unit configured to perform a lifting action in the process of erecting the crane tower,
a slewable jib unit configured to be mounted on top of the crane tower,
wherein the crane base, crane tower lifting unit, and slewable jib unit are configured to be combined to an assembly that is to be arranged at the hoisting site in an initiation state thereof, the assembly in said initiation state comprising:
   the crane base placed on the support at the hoisting site,
   the crane tower lifting unit pivotally mounted to the crane base and oriented horizontally,
   the slewable jib unit connected to the crane tower lifting unit and oriented horizontally,
wherein the interconnected crane tower lifting unit and slewable jib unit are pivotal relative to the crane base into a vertical orientation in an upending step,
and wherein the crane is configured to—with the interconnected crane tower lifting unit and slewable jib unit in said vertical orientation—erect the crane tower by stacking tower segments one-by-one onto one another to lengthen the crane tower under the jib unit, wherein the crane tower lifting unit is configured to perform a lifting action in association with the stacking of a tower segment.

In an embodiment, the assembly that is to be arranged at the hoisting site in an initiation state thereof further comprises a pivoting actuator mechanism that is configured to pivot the interconnected crane tower lifting unit and slewable jib unit into the vertical orientation in the upending step. In another embodiment, an auxiliary crane is used for the upending of this assembly.

In an embodiment of any aspect of the invention, the tower crane comprises:
a first road vehicle configured to transport the crane base and the crane tower lifting unit to the hoisting site, wherein the lifting unit is pivotally mounted to the crane base and is oriented horizontally on the first road vehicle,
a second road vehicle configured to transport the slewable jib unit to the hoisting site, wherein the jib unit is oriented horizontally on the second road vehicle,
and wherein the second road vehicle can be manoeuvred in alignment with the horizontally oriented crane tower lifting unit and the slewable jib unit and is then connectable to the crane tower lifting unit.

In an embodiment of any aspect of the invention, a first road vehicle forms at least a part of the crane base, e.g. the first road vehicle having a chassis, e.g. a trailer chassis, that forms at least a part of the crane base.

In an embodiment of any aspect of the invention, a second road vehicle also forms a part of the crane base, e.g. each of the first and second road vehicle have a chassis, e.g. a trailer chassis, that forms a part of the crane base, wherein, preferably, the chassis of the first and second road vehicles are mechanically interconnectable to form a rigid component of the crane base.

In an embodiment of any aspect of the invention, the slewable jib unit comprises a slew bearing mounted between a lower jib unit structure that is to be connected to the crane tower or the crane tower lifting unit and an upper jib unit structure, a jib that is pivotally mounted to the upper jib unit structure about a jib pivot axis, a jib luffing mechanism configured to luff the jib, a winch and associated hoisting cable depending from a sheave assembly on the jib.

The present invention also relates to the assembly of a wind turbine, wherein use is made of a method and/or tower crane according to any one or more of the aspects as discussed herein. For example, the mast of the wind turbine is assembled from mast parts that are stacked on top of one another using the tower crane. For example, the crane tower is extended after placement of a mast part, so the crane grows along with the wind turbine mast.

The present invention also relates to a method for installing or de-installing of a wind turbine component, e.g. a rotor blade, a nacelle component, etc., wherein use is made of a method and/or tower crane according to any one or more of the aspects as discussed herein. For example, the nacelle is composed of multiple parts so as to stay within the hoisting capacity of the tower crane. For example, a hub part and a generator part are handled by the tower crane as separate loads to be hoisted, e.g. with another separate part forming the housing of the nacelle.

The present invention also relates to a tower crane according to any one or more of the aspects as discussed herein, wherein the initiation has been done without the pivoting as discussed of the lifting unit and the jib unit in unison.

### BRIEF DESCRIPTION OF THE DRAWINGS

The invention will now be discussed with reference to the drawings. In the drawings:

FIG. 1 shows an example of a self-climbing tower crane according to the invention which is arranged on a support at a hoisting site adjacent a wind turbine mast already provided with a nacelle, the crane being used for installation of wind turbine blades to the nacelle,

FIG. 2 shows the crane of FIG. 1 for installation of the nacelle on top of the wind turbine mast,

FIG. 3 shows the crane of FIG. 1 during installation of a wind turbine blade,

FIG. 4 shows the lower part of FIG. 1 on a larger scale,

FIG. 5 shows the upper part of FIG. 1 on a larger scale,

FIG. 6a shows the upper stabilizer device and upper tower segment of the crane tower of FIG. 1 in absence of the wind turbine mast for clarity,

FIG. 6b shows the region where the upper section of the crane tower of FIG. 1 adjoins the lower section and the lower stabilizer device engages the wind turbine mast,

FIGS. 7a, b show side views of an upper tower segment of the crane of FIG. 1,

FIGS. 8a,b,c show a top view, a cross-section, and a bottom view of the upper tower segment of FIGS. 7a,b,

FIG. 9 shows the crane of FIG. 1 during the assembly process adjacent a wind turbine mast, wherein two more upper tower segments have already been connected to the first upper tower segment, and wherein the lower stabilizer device is arranged between the upper section of the crane tower and the wind turbine mast,

FIG. 10 shows the lower stabilizer device in opened, non-clamping state thereof,

FIG. 11 shows the arranging of the upper stabilizer device,

FIG. 12 shows the lifting of the upper stabilizer device along the upper section,

FIG. 13 shows the addition of another upper segment to the upper section and the lifting of the already assembled part of the crane tower by the lifting unit,

FIG. 14 shows the further lifting of the upper stabilizer device along the upper section,

FIG. 15 shows the upper section of the crane tower being completed and a first lower tower segment being connected below the complete upper section and being lifted by the lifting unit,

FIG. 16 shows the continued assembly of the crane tower by addition of further lower tower segments and stepwise lifting of the crane tower by the lifting unit, as well as arranging the lower stabilizer device at the lower end of the upper section of the crane tower,

FIG. 17 shows moving the upper stabilizer device along the upper section of the crane tower upward by means of the hoisting device,

FIG. 18 shows the first transportable assembly of the crane of FIG. 1 being parked at the hoisting site and the second transportable assembly, formed by the slewable jib unit of the crane, being supplied by means of a second road vehicle, the slewable jib unit being lifted by an auxiliary crane,

FIG. 19 shows the slewable jib unit being connected to the upper tower segment whilst the crane tower lifting unit is oriented horizontally,

FIG. 20 shows a part of FIG. 19 on a larger scale,

FIG. 21 shows the upended combination of the lifting unit and interconnected slewable lifting unit as well as the auxiliary crane,

FIG. 22 shows the site with the crane in the state of FIG. 21 from above,

FIG. 23 shows the construction of a wind turbine mast using the crane of FIG. 1, wherein a second mast member is stacked onto a first or lowermost mast member,

FIG. 24 shows a part of FIG. 23 on a larger scale,

FIG. 25 shows a further stage of the construction of the wind turbine mast using the crane of FIG. 1,

FIGS. 26a, b show schematically, in a side view and from above, a first road vehicle of which the trailer forms part of the crane base, the crane tower lifting unit being pivotally connected to the crane base and in horizontal orientation,

FIGS. 27a, b show schematically, in a side view and from above, a second road vehicle of which the trailer forms part of the crane base, the slewable jib unit loaded on the trailer in horizontal orientation thereof,

FIGS. 28a,b,c illustrate the parking of the first road vehicle at the hoisting site, the manoeuvring of the second road vehicle in alignment with the trailer of the first road vehicle, the interconnecting of the slewable jib unit loaded on the second road vehicle with the lifting unit on the first road vehicle prior to upending,

FIG. 29a shows the provision of an upending frame,

FIG. 29b shows the start of upending of the interconnected lifting unit and slewable jib unit,

FIG. 30 shows the end of the upending step, wherein the interconnected lifting unit and slewable jib unit are oriented vertically on the crane base,

FIG. 31 shows the provision of the stabilizing frame members for stabilizing the upended lifting unit,

FIG. 32 shows the handling of a crane tower segment by means of the jib unit, wherein the tower segment is placed on a tower segment handling device in the second position thereof,

FIG. 33 shows the tower segment being shifted by means of the tower segment handling device to the first position thereof underneath the lifting unit,

FIGS. 34a-d illustrate the stacking of a new tower segment underneath a tower segment retained in the lifting unit and the subsequent lift action of the crane tower by means of the lifting unit,

FIG. 35 illustrates the continued lengthening of the crane tower by adding new segments as well as the luffing motion of the jib,

FIGS. 36a,b, c show the crane tower segment in side views and in top view,

FIGS. 37 and 38 show the crane of FIGS. 26-36 erected alongside a wind turbine,

FIG. 39 shows the situation of FIGS. 37, 38 in a plan view,

FIG. 40 illustrates the support struts of the crane base being deployed.

FIGS. 41a, b show schematically, in a side view and from above, a second embodiment of the first road vehicle of which the trailer forms part of the crane base, the crane tower lifting unit being pivotally connected to the crane base and in horizontal orientation, the trailer being parked in close proximity of the foot of a wind turbine mast,

FIG. 42a, b show schematically, in a side view and from above, the trailer of the first road vehicle of FIGS. 41a,b, with the outward swinging support struts stabilizing the trailer on a support, for example a hardstand, as well as an umbilical winch,

FIG. 43 shows the manoeuvring of the second road vehicle in alignment with the trailer of the first road vehicle, the interconnecting of the slewable jib unit loaded on the second road vehicle with the lifting unit on the first road vehicle prior to upending,

FIG. 44 shows from above the situation of FIG. 43, with an auxiliary mobile crane arranged in proximity of the trailers,

FIG. 45a illustrates a first stage of the upending of the interconnected lifting unit and slewable jib unit using the auxiliary mobile crane,

FIG. 45b shows the auxiliary mobile crane of FIG. 20a,

FIG. 46a shows from above the first stage of the upending of the interconnected lifting unit and slewable jib unit using the auxiliary mobile crane,

FIG. 46b illustrates the second stage of the upending of the interconnected lifting unit and slewable jib unit using the auxiliary mobile crane,

FIG. 46c illustrates the auxiliary mobile crane at the end of the second stage,

FIGS. 47a, b show the handling of a crane tower segment by means of the auxiliary mobile crane and the connection thereof to the tower segment retained in the lifting unit,

FIG. 47c the subsequent lift action of the crane tower by means of the lifting unit,

FIG. 47d the connection of yet another tower segment underneath the crane tower,

FIG. 47e illustrates the step of FIG. 47a in a 3D view,

FIG. 48a illustrates the placement of a guy arrangement that connects the crane tower to the mast of the wind turbine,

FIG. 48b illustrated the guy arrangement of FIG. 48a,

FIGS. 49a,b illustrate the handling of a wind turbine blade using the tower crane of FIGS. 41-48,

FIG. 50 illustrates the handling of a nacelle without gearbox and hub assembly and the handling of the gearbox and hub assembly by means of the tower crane of FIGS. 41-48.

### DETAILED DESCRIPTION OF EMBODIMENTS

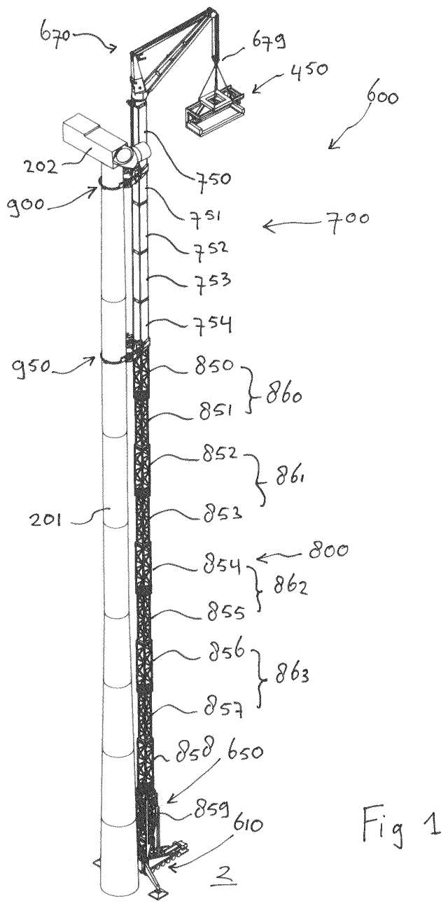

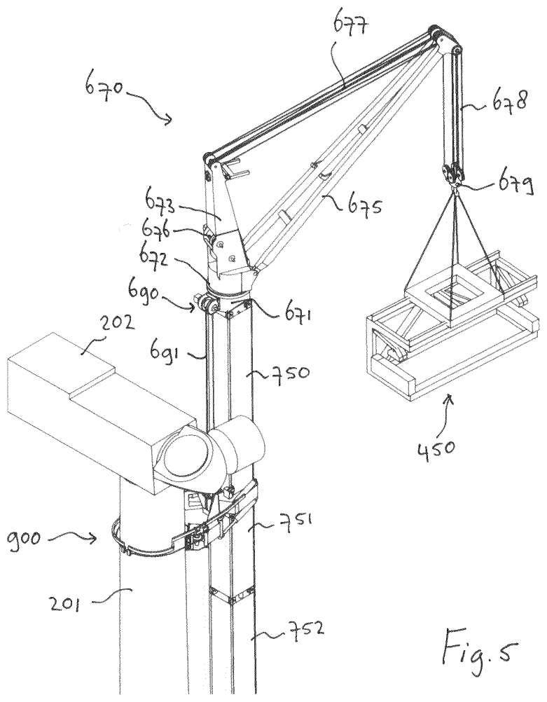

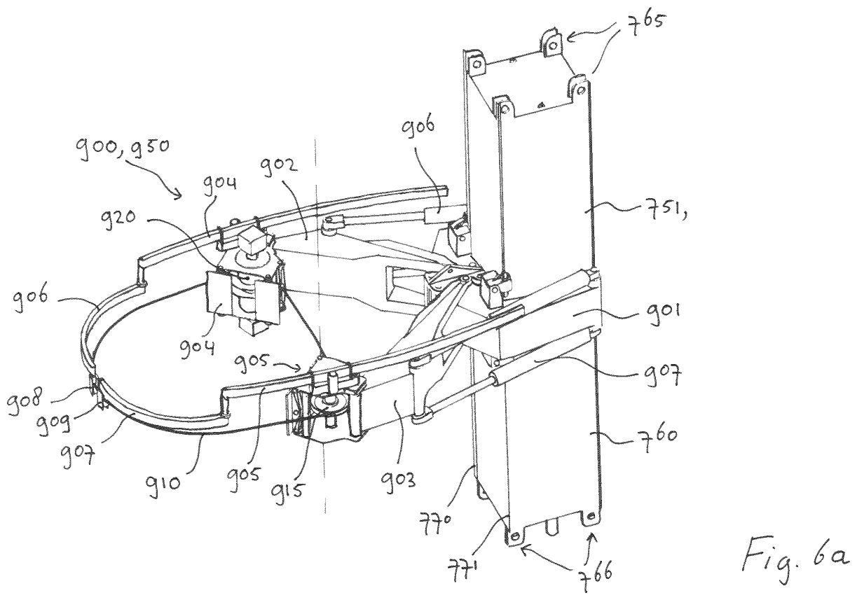

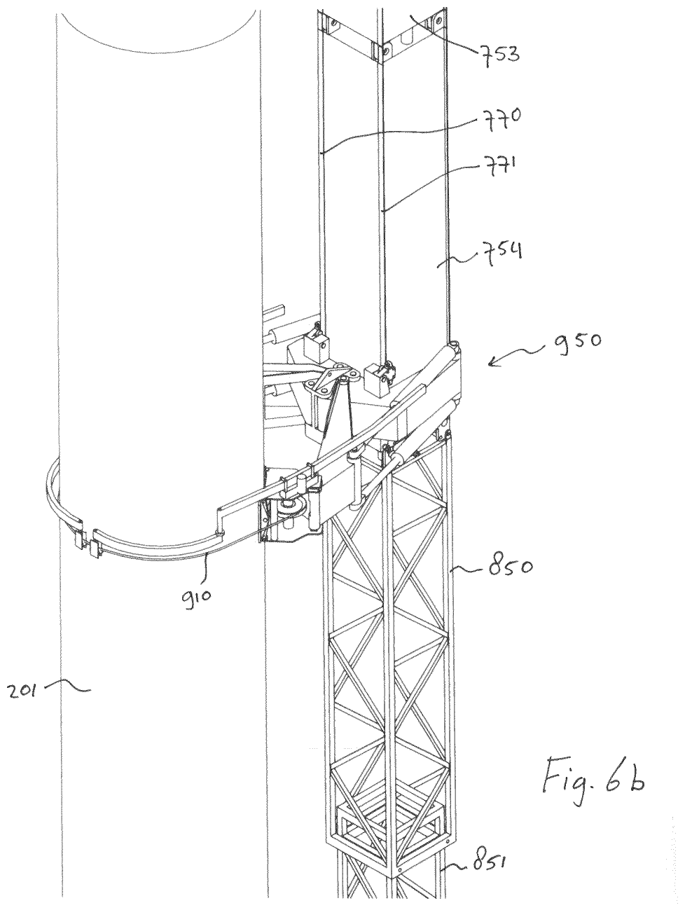

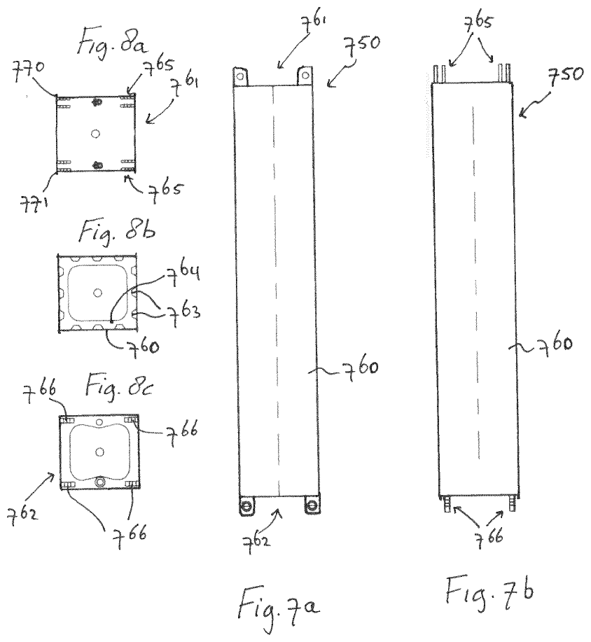

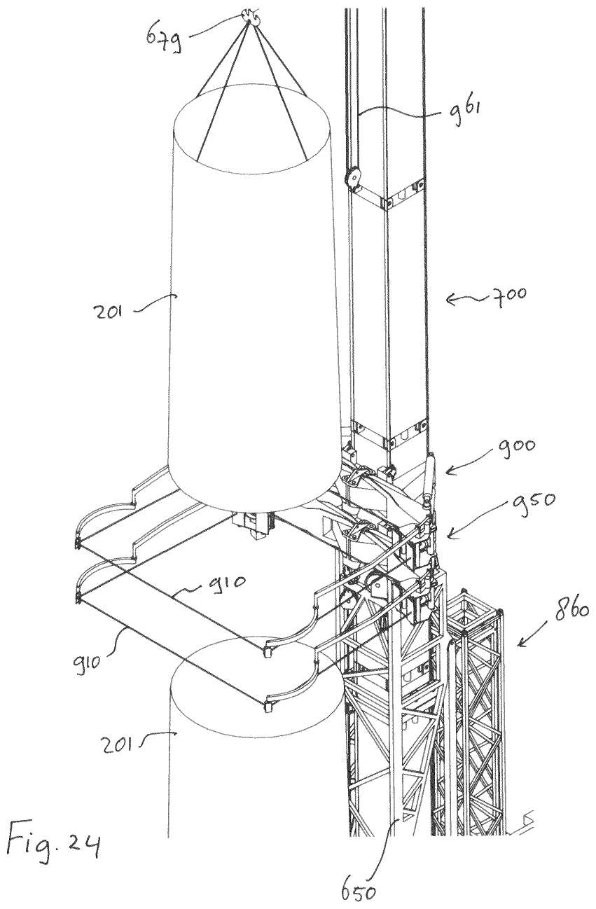

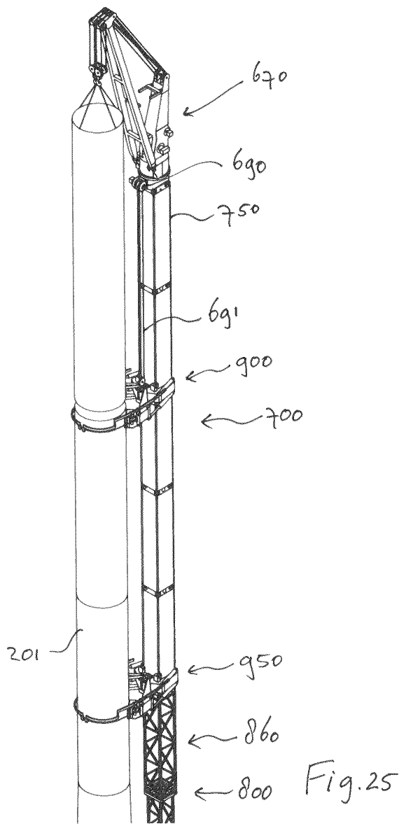

With reference to the FIGS. 1-25 an example of a self-climbing tower crane 600 according to the invention will now be discussed, as well as the use of the tower crane, in particular in the field of wind turbines.

In FIG. 1 the reference numeral 2 denotes the support at a hoisting site, here adjacent the foot of an already built wind turbine mast 201 on top of which nacelle 202 has already been mounted (e.g. using the same tower crane 600). The three wind turbine blades are still to be installed, using the tower crane 600.

For example, as shown here, the wind turbine mast 201 is land-based. In another example, the wind turbine is only temporarily arranged on land, e.g. during assembly of an offshore wind turbine at an onshore production site, which wind turbine is then transported to an offshore location in some configuration of the wind turbine (e.g. without blades being mounted, or with blades mounted). In yet another example, the support 2 is formed by an offshore foundation for the wind turbine, e.g. a floating foundation or a soil-bound foundation.

For example, as shown here, the support 2 is embodied as a so-called hard stand configured to arrange the tower crane 600, possibly also one or more auxiliary cranes 300, thereon.

Generally, the tower crane 600 comprises:
a crane base 610 which is configured to be placed on the support 2 at the hoisting site, here embodied with a trailer 612 of a road vehicle,
tower segments 750-754, 850-859 which are configured to be stacked onto one another from below in order to erect a crane tower which is composed of the tower segments on the crane base,
a crane tower lifting unit 650 mounted on the crane base 610 and configured to perform lifting actions in the process of stacking of the tower segments 700, 800, wherein the crane tower lifting unit 650 stepwise lifts the crane tower from below,
a slewable jib unit 670 which is configured to be mounted on top of the crane tower.

The tower crane 600 is configured to—with the slewable jib unit 670 connected to an upper tower segment 750—erect the crane tower by stacking tower segments onto one another from below to lengthen the crane tower under the slewable jib unit 670.

Generally, the crane tower comprises an upper section 700 composed of a series of multiple upper tower segments 750-754, here five, and a lower section 800 composed of a series of multiple lower tower segments 850-859. The lower section 800 supports the upper section 700 thereon.

In the depicted embodiment, the upper section 700 is composed of five upper tower segments 750-754, preferably identical upper tower segments at least concerning main dimensions thereof as height and horizontal cross-section.

Each upper tower segment 750-754 is embodied as a tubular girder type tower segment having a height and having an outer peripheral wall 760 which is made of steel plate. Each segment 750-754 also has upper and lower end portions 761, 762 that are each provided with connectors 765, 766, allowing to rigidly interconnect the upper tower segments 750-754.

Generally each lower tower segment 850-859 is embodied as a latticed structure type tower segment having a height, having a main chord at each corner, and bracing between adjacent main chords, wherein the main chords are provided at ends thereof with connectors to rigidly interconnect the lower tower segments. As will be discussed in more detail below, the FIG. 1 shows an embodiment of the lower section 800 wherein use is made of telescopic latticed tower segment assemblies 860-864.

The FIG. 1 also shows the presence of one upper external stabilizer device 900 and one lower stabilizer device 950, each configured to horizontally connect the upper section 800 of the crane tower to the wind turbine mast 201.

The jib unit 670 comprises a slew bearing 672 which is mounted between a lower jib unit structure 671 that is connected to the first upper tower segment 750 (as will be discussed in more detail below) and an upper jib unit structure 673. A slew drive is present as well.

The jib unit 670 further comprises a jib 675 that is pivotally mounted to the upper jib unit structure 673 about a jib pivot axis 674.

In this example, the jib unit is embodied with a cable luffing mechanism comprising luffing cables 677 extending between an outer end of the jib 675 and an upward protruding portion of structure 673, the cables 677 extending to one or more luffing winches. This jib luffing mechanism is configured to luff the jib 675 up and down.

The jib unit 670 further comprises a hoist winch 676 and associated hoist cable 678 which runs over sheaves of the jib 675 to a travelling block 679 of the crane, here with a swivelling crane hook.

As preferred, the jib 675 is a rigid jib lacking articulation and telescopic operation. Other embodiments of the jib are also possible, e.g. as in mentioned prior art documents. However, the use of a rigid and luffable jib 675 having an inner end pivotally secured to the structure 673 is preferred.

For example, the jib has a length of at least 10 meters, e.g. between 12 and 18 meters.

As shown, and as preferred, the jib unit 670 is devoid of any counter ballast.

FIG. 1 shows that a blade lifting tool 450 is suspended from the crane hook 679. As known in the art, the tool 450 can be used to connect to a wind turbine blade 203, e.g. transported by means of special road vehicles onto the support. The tower crane 600 is then operated to hoist the blade 203, whilst remaining horizontal as preferred, to the height of the nacelle 202 of the wind turbine. This application is illustrated in FIG. 3.

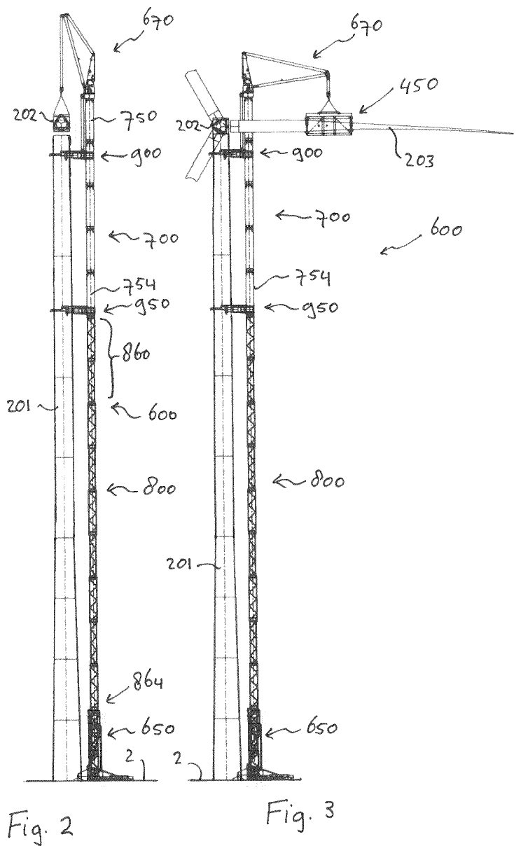

For example, the tower crane 600 has a hoisting capacity of at least 100 tonnes, e.g. between 100 and 150 tonnes. This not only allows for hoisting of sizable blades 203. The tower crane 600 may also be used for lifting a nacelle 202 up to the top of the mast 201 in the process of mounting the nacelle, as is shown in FIG. 2. Possibly, the nacelle 202 is first lifted and installed without heavy equipment therein, e.g. without a gearbox and/or generator, the heavy equipment being lifted by the tower crane 600 in a further hoisting job and then installed in the nacelle 202. The crane 600 can also be used for other operations, e.g. removal of a defect wind turbine blade, generator, gearbox, etc. And, clearly, the crane can also be used for hoisting jobs in conjunction with another tall external object, e.g. a building.

The upper section 700 effectively forms a lengthy and sturdy vertical oriented box structure which distributes the crane loads over the upper and lower stabilizer devices 900, 950 that connect the upper section 700 at two vertically spaced apart levels to the wind turbine mast 201. These loads include torsional loads acting about a vertical axis on the crane tower. For example, the loads are due to the jib and the object that is hoisted being offset from the vertical axis of the crane tower, and/or due to slew motions of the jib unit, wind forces acting on the load (e.g. on a wind turbine blade 203 that is hoisted).

Due to this design of the crane tower 600 an optimal stability and load absorption of the crane tower can be achieved at an attractive weight of the crane tower, e.g. compared to the known designs wherein the crane tower is completely composed of lattice structure type tower segments. Also, undue loads on the stabilizer devices 900, 950 and of the stabilizer devices onto the wind turbine mast 201 can be avoided.

As shown, the upper and lower stabilizer devices 900, 950 are configured to engage on the wind turbine mast, which is as is common of circular cross-section, and is configured to frictionally engage on the wind turbine mast.

As shown the stabilizer devices 900, 950 are each provided with a mast encircling assembly which is configured to frictionally engage on the mast 201. Due to the effective absorption and distribution of loads via the box structure of the upper section damage to the wind turbine mast, e.g. to a coating thereof, due to too much stress can be avoided.

As shown in FIG. 8b, the outer peripheral wall of steel plate is internally reinforced by longitudinal stiffeners 763 extending along the height of the peripheral wall 761.

As shown in FIG. 8b, one or more diaphragm plates 764 are present inside each upper tower segment 750-754

Each upper tower segment 750-754 has a height of at least 6 meters, e.g. between 8 and 12 meters, here of 10.8 meters. It is noted that the figures are on scale.

The height of the upper section 700 is at least 10%, preferably at least 20%, and at most 50% of the height of the crane tower when at its operational height.

As shown, the upper section preferably protrudes above the top of the mast 201, more preferably above the top side of the nacelle 202. This allows for effective manoeuvring with the crane.

As shown, the height of the upper section is at least 25 meters, e.g. between 40 and 60 meters. As shown in FIG. 1 the upper section 700 is just over 50 meters high.

As shown, each of the lower and upper stabilizer devices 900, 950 is configured to travel up and down along the upper section 700.

In more detail, the upper tower segments 750-754 are each provided with at least one guide rail, here a pair of guide rails 770, 771 which extend along the height of the upper tower segment 750-754 such that guide rails of the interconnected upper tower segments form a substantially continuous guide rail. The stabilizer devices 900, 950 are each configured to travel up and down along the continuous guide rail of the upper section 700 for example during erecting of the tower crane 600 in the manner as will be explained below.

For example, as shown, the upper tower segments 750-754 are square in horizontal cross-section, wherein at least one pair of guide rails 770, 771 is provided on each upper segment, each guide rail 770, 771 being present at a respective corner of the upper segment.

As shown, for example in FIGS. 1-4, the lower tower segments 850-859 are not embodied as regular individual, fixed height tower segments. Instead, the lower section 800 is here composed of multiple telescopic latticed tower segment assemblies 860-864.

As shown, each of these assemblies 860-864 is composed of an outer lower tower segment and an inner lower tower segment which is slidably mounted in the outer lower tower segment and is slidable between a retracted position and an extended position.

As shown, each of the inner and outer lower tower segments in these assemblies 860-864 is embodied as a latticed structure type lower tower segment having a height and having a main chord at each of the four corners and bracing members, e.g. diagonal and/or horizontal between adjacent main chords.

The inner and outer lower tower segments of an assembly 860-864 are provided with locking members, e.g. holes through which a pin can be fitted when the holes are aligned, configured to lock the inner lower tower segment in the extended position thereof relative to the outer lower tower segment.

As shown, the assemblies 860-864 are here mounted with the outer lower segment at the top of the extended assembly. The inner lower tower segment is provided with connectors to connect the inner lower tower segment to an outer lower tower segment of another telescopic latticed tower segment assembly, and the outer lower tower segment is provided with connectors to connect the outer lower tower segment to an inner lower tower segment of another telescopic latticed tower segment assembly.

As shown multiple adapter members 870 are provided in the crane tower lower section 800. Each adapter member 870m has at the lower side thereof connectors configured to mate with connectors of an outer tower segment and at the upper side thereof connectors configured to mate with connectors of an inner tower segment.

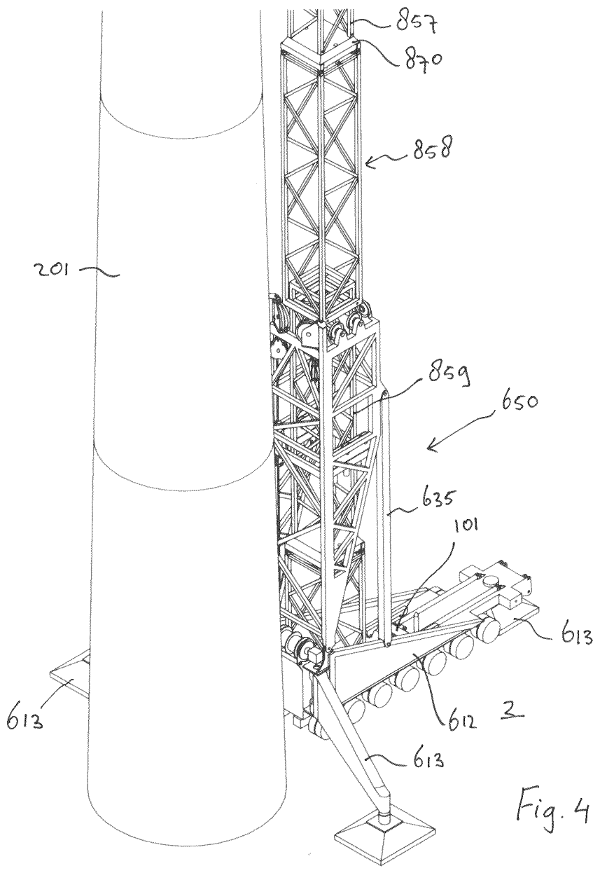

The lifting unit 650 is configured to handle these telescopic assemblies 860-864, as shown in, for example, FIG. 4. The outer lower segment of a new assembly is lifted upward, whilst the inner lower segment does not follow so that the assembly is extended. Once the inner and outer lower segments are locked to one another, the inner segment is engaged by the lifting unit 650 and is lifted upward so that the entire assembly is moved upward in extended configuration.

As shown, the lifting unit 650 may comprises a system of one or more winches and winch driven cables to move corresponding engagement members of the lifting unit up and down in a controlled manner, so as to controllably move the assembled part of the crane tower with the jib unit 670 thereon. In another embodiment, the lifting unit 650 has hydraulic cylinders to perform the stepwise lifting operation when assembly of the crane tower takes place.

In particular the FIGS. 4, and 18-22, show that, in a preferred embodiment, the crane tower lifting unit 650 is pivotally mounted to the crane base 612 so as to be pivotal between a horizontal and a vertical orientation.

The first upper segment 750 is arranged in the crane tower lifting unit 650, preferably already when arriving at the site.

As shown, the crane base 612 and crane tower lifting unit 650 mounted thereon with the first upper segment 751 arranged therein form a first transportable assembly which is configured for road transportation.

As shown, the crane base 610 is embodied as a trailer 612 of a first road vehicle.

The trailer 612 is provided with deployable, here including two outward swinging, support struts 613 to stabilize the trailer 612 on the support 2, for example a hardstand at the hoisting site, e.g. in proximity and/or even on the foundation of wind turbine 200

The slewable jib unit 670 forms a second transportable assembly and is transported to the site loaded on a trailer 632 of a second road vehicle 630 as shown in FIG. 18.

With the first transportable assembly, here including trailer 612, arranged at the hoisting site, the slewable jib unit 670 is connected to the upper segment 750 whilst the crane tower lifting unit 650 is oriented horizontally.

As shown in FIGS. 18, 19, 20 the unit 670 may be lifted by auxiliary crane 300 from the trailer 632 and then, whilst generally horizontal with the jib 675 extending away from the lifting unit 650, connected, e.g. using a pin connection, with the structure 671 to the top end of upper segment 750.

The crane tower lifting unit 650 with upper segment 750 therein and the slewable jib unit 670 are then together pivoted relative to the crane base 612 into a vertical orientation in an upending process. As shown an auxiliary crane 300 is used in the upending, wherein the crane tower lifting unit 650 and slewable jib unit 670 are pivoted relative to the crane base 612 into a vertical orientation of the tower lifting unit 650.

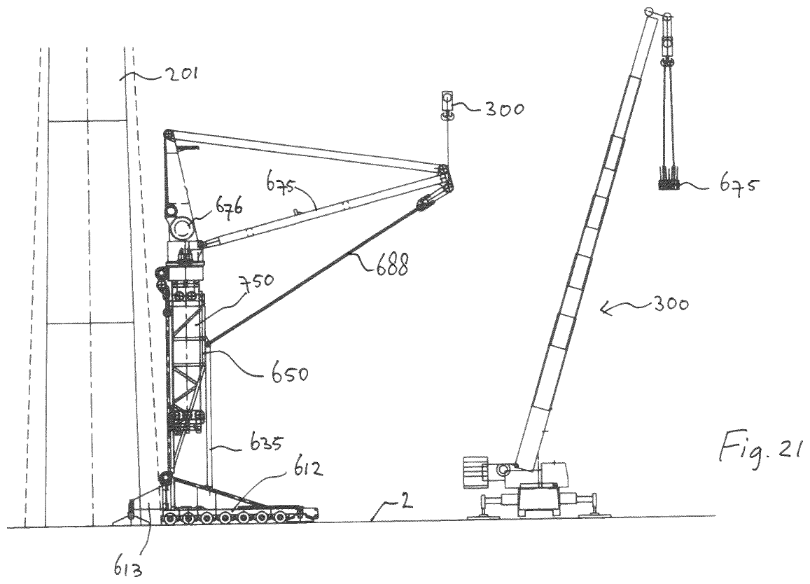

FIG. 21 shows that, in an embodiment, the jib 675 may be pivoted downward during the upending process and tied to the lifting unit 675 using a temporary sling 688. For example, the crane 300 initially engages on the interconnected units 650, 670 near the winch 676 of the jib unit to pivot the ensemble to about 45 degrees. Then the luffing mechanism is operated to lower the jib 675, e.g. the end supported on the support 2. Then the sling 688 is provided to keep the jib 675 in this position. The crane 300 can then be connected to the end of the jib 675 as shown in FIG. 21 and pivoting of the ensemble can continue, until the unit 650 is vertical.

As shown in FIG. 4, after completion of the upending step, one or more stabilizing frame members 635 are arranged between the crane base, here the trailer 612, and the upended lifting unit 650 to keep the unit vertical.

The assembly of the crane 600 further comprises a crane tower assembly phase, in which—with the interconnected crane tower lifting unit 650 in vertical orientation—the crane tower is erected by first stacking one or more additional upper tower segments 751-754 one-by-one underneath the first upper tower segment 750 to form the upper section 700 of the crane tower and then stacking lower tower segments, here using the assemblies 860-864 one-by-one underneath the upper section 700 to form the lower section 800 of the crane tower. Herein the crane tower lifting unit 650 performs lifting actions in association with the stacking of tower segments.

In FIG. 9, the crane of FIG. 1 is shown, wherein two more upper tower segments 751, 752 have already been connected from below to the first upper tower segment 751. The lower stabilizer device 950 is arranged between the partly completed upper section 700 of the crane tower and the wind turbine mast 201. This done by auxiliary crane 300.

In FIG. 10 it is shown that the lower stabilizer device 950 initially is in opened, non-clamping state thereof.

The stabilizer devices 900, 950 are generally of the same design. The device has a frame 901 that is configured to be mounted to the crane tower, here U-shaped when seen from above. The devices 900, 950 are each, preferably, as shown, embodied in two halves, allowing to mount a lefthand part of the device from the left side and a righthand part of the device from the right side, wherein the parts are then interconnected, e.g. via the frame halves.

The frame supports two pivotal arms 902, 903 that have one end pivotally connected to the frame 901 about a vertical pivot axis. The other end of the arms 902, 903 each carry a pad, here pads 904, 905, to frictionally support the arm end against the exterior of the mast 201. Pivoting and positioning of the arms 902, 903 may be done with an actuator system, e.g. a hydraulic cylinder 906, 907 for each arm as shown.

The devices 900, 950 comprise, in addition to the arms, a mast encircling member or assembly 910, for example a strap or rope, or the like, that can be arranged in the crane assembly process to encircle the mast 201. For example, the strap or rope 910 is connected to one of the arms 902 at one end and then extends about the mast 201 to the other arm end, and is then tensioned by a tensioning device, here a winch 920. In this example, the strap or rope passes over a sheave 915 at the other arm end of arm 903 to the winch 920 mounted on the other arm 902.

In order to facilitate the operation of the devices 900, 950 with the mast encircling strap or rope 910, a support bracket is provided on each of the arms 902, 903 which supports the strap or rope at least at one location.

In more detail, in the illustrated embodiment each support bracket on an arm 902, 903 comprises an elongated rod member 904, 905 mounted on the arm 902, 903 and extending away from the arm end to an outer end of the elongated rod member. At the outer end of the rod member an articulated curved rod member 906, 907 is hinged about a vertical hinge axis. This curved rod member 906, 907 has an eye 908, 909 through which the strap or rope is passed. Preferably, the curved rod member is biased, e.g. by a spring, into an outward direction, away from the curved rod member of the opposite support bracket. Swinging.

To have a frictional clamping of the devices 900, 950 onto the exterior of the mast 201, which is circular in cross-section, starting from the state shown in FIG. 10, the actuator system thereof is operated to clamp the pads 904, 905 against the mast 201. Also the winch 920 or other tensioner is operated to tension the strap or rope 910 about the mast. Herein, the curved rod members 906, 907 of the device are moved towards one another.

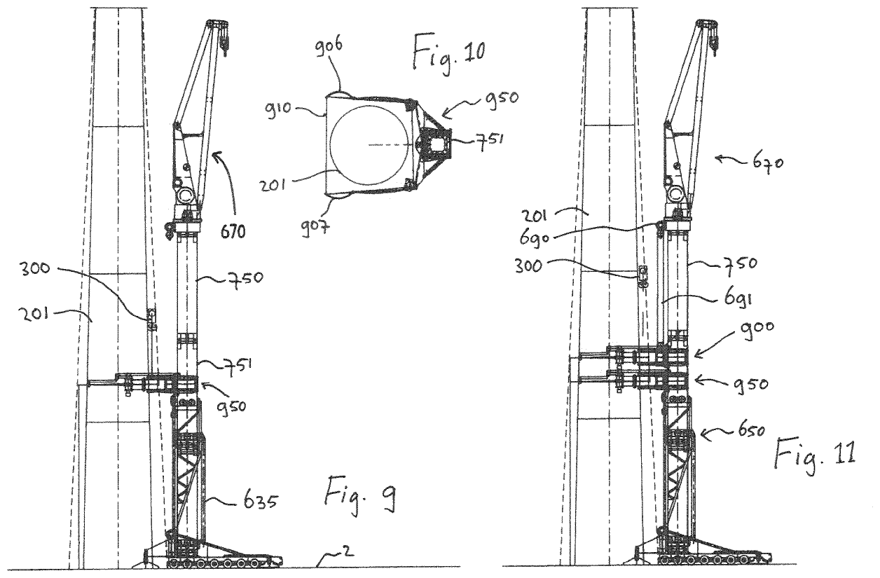

The FIG. 11 shows the arranging of the upper stabilizer device 900, here just above the lower stabilizer device 950, using the auxiliary crane 300. The arranging of the stabilizer devices 900, 950 is done at a relatively low height above the support 2.

In FIGS. 9 and 11 also a hoist device 960 is shown, which is provided on the jib unit 670 and is configured to hoist the upper stabilizer device 900 along the upper section 700 of the crane 600, in particular during the assembly process of the crane tower.

It is shown here that the upper stabilizer hoist device 960 is configured to provide a constant lift force mode allowing to suspend the upper stabilizer device 900 from the hoist device 960 with a constant lift force. This allows for the upper stabilizer device 900 to be stationary relative to the external tall structure whilst the crane tower is extended from below, thereby supporting at least part of the weight of the upper stabilizer device 900.

In embodiments, as shown here, the hoist device 960 is a winch driving hoist cable 961. In this example, the winch 960 is embodied to have a constant tension mode for cable 961.

In FIG. 12 the vertical arrow indicates that the hoist device 960 is operated to hoist the upper stabilizer device 900 along the upper section 700. The FIG. 12 shows that the stabilizer device 900 is in its opened state when at the lower level and once the higher level is reached, e.g. close to the upper end of crane tower, the stabilizer device 900 is clamped onto the mast 201.

The FIG. 13 shows the addition—from below—of another upper segment 753 to the upper section and the lifting of the already assembled part of the crane tower by the lifting unit 650.

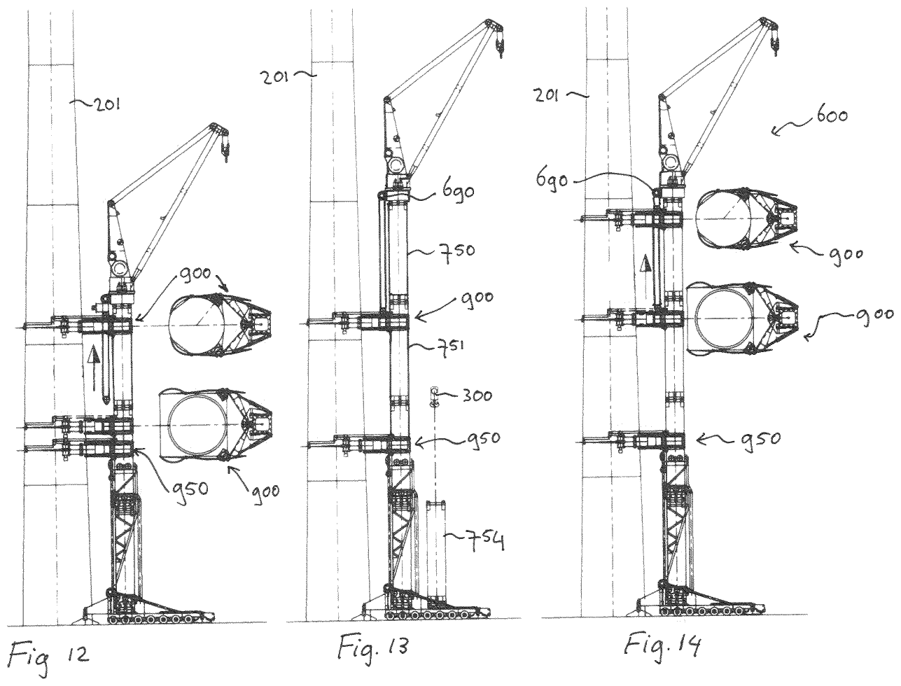

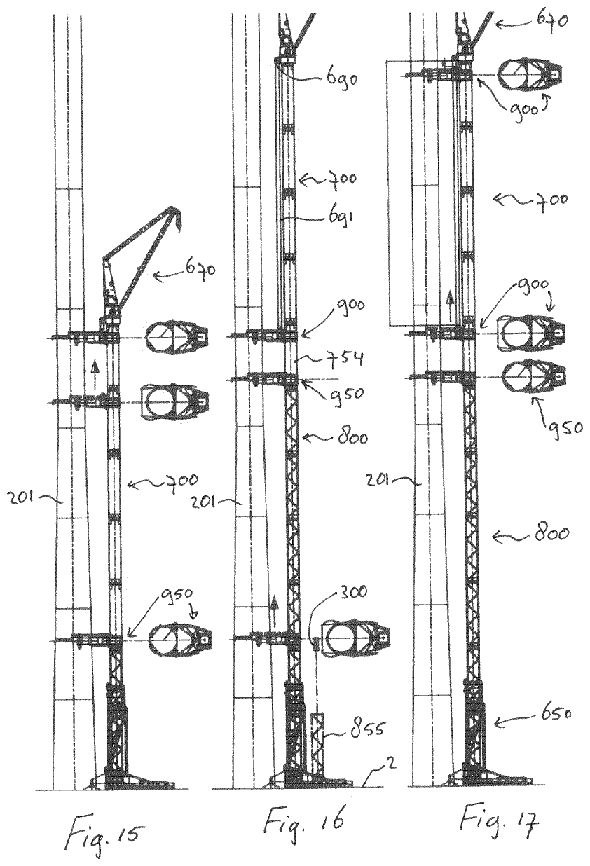

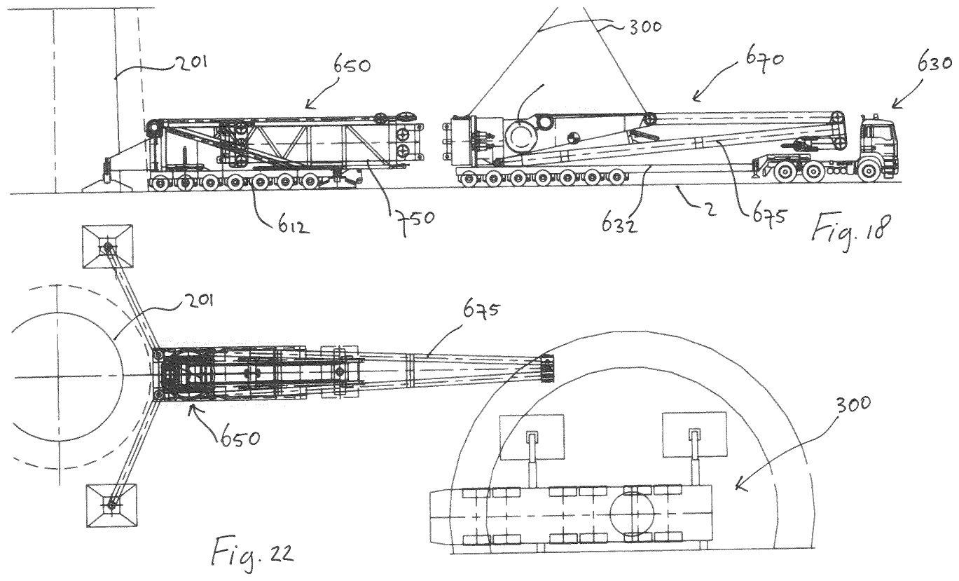

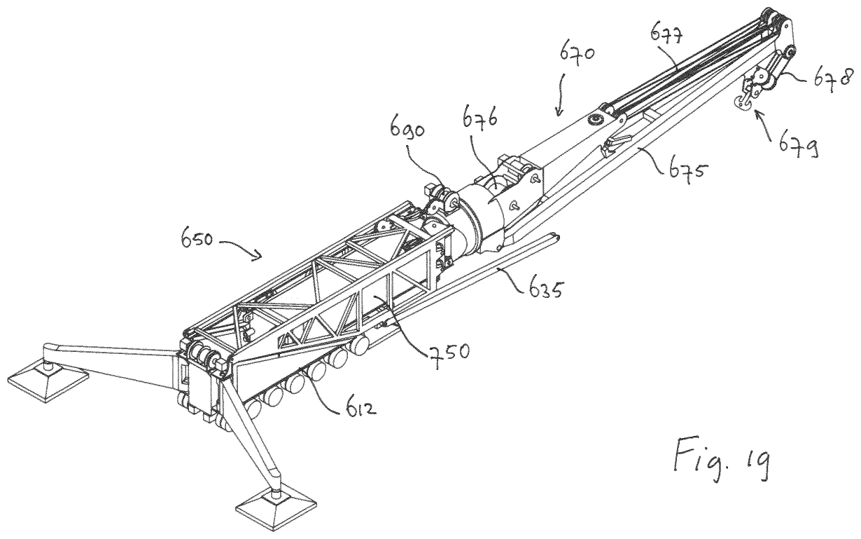

Handling of the segments to be joined to the crane tower may be done using the auxiliary crane 300. For example, the segment to be joined is vertically placed on a cart 101 (see e.g. FIG. 4) that is movable over rails of the device, e.g. in longitudinal direction of the trailer 612 between a second position thereof shown in FIG. 13 and the first position thereof shown in FIG. 14, so that the segment becomes arranged underneath the lifting unit 650.

FIG. 13 also shows that the lifting unit 650 has been operated to move the crane tower a further upper segment upwards. Herein, the stabilizer devices 900, 950 have remained stationary relative to the mast 201, with the stabilizer device 900 suspended from the cable 961 held by the winch 960 at a constant tension. So, during lifting of the crane tower, the winch 960 pays out cable 961 at the constant tension, which avoids that the device 900 is effectively hanging from the mast 201 as the latter might cause damage to (coating of) the mast 201 and/or overload the mechanism of the device 900 that frictionally holds the device 900 onto the mast.

In this phase, the lower stabilizer device 950 is effectively resting on the lifting unit 650.

FIG. 14 shows, as illustrated by the vertical arrow, the further lifting of the upper stabilizer device 900 along the upper section 700 as the latter has been extended upward. As shown in FIG. 14 this involves undoing the clamping of the mast 201 by the device 900, operating the winch 690 to hoist the device 900, and then clamping the device 900 onto the mast 201 again.

The extending of the crane tower is continued such that the upper section 700 is completed, here made up of five upper segments 750-754. At some point, the lower end of the upper section becomes aligned with the lower stabilizer device 950 which is still clamped about the mast 201.

As shown in FIG. 15, the lower stabilizer device 950 may now be connected to the lower end of the upper section 700 so that further upward extension of the crane tower by stepwise completion of the lower section 800 also moves the (then unclamped) lower stabilizer upward along the mast 201. The upper stabilizer device 900 can remain clamped onto the mast 201 suspended from the constant tension mode winch 960 and cable 961 until the crane tower has been extended such that the lower device 950 comes near. This is shown in FIG. 16.

The FIG. 17 shows the continued assembly of the crane tower. Herein, the upper stabilizer device 900 is unclamped, then moved upward by means of the winch 960, and then clamped onto the mast 201 with the winch 960 ten being brought again in constant tension mode for a further extension phase of the crane tower. The lower stabilizer device 950 is then unclamped so as to move upward along with the extension of the crane tower. In the end the situation shown in FIGS. 1, 2, and 3 can be reached with the crane tower fully completed.

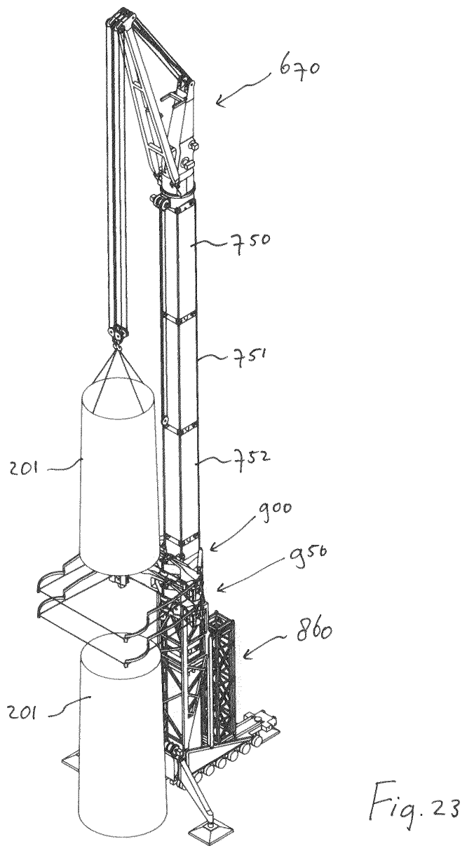

As shown in FIGS. 23, 24, and 25 the same crane 600 can also be used for construction of the mast 201 of the wind turbine from mast parts that are stacked onto one another. This construction of the mast 201 can go coordinated with the completion of the crane tower, so as to have optimum use of the stabilizer devices 900, 950 (shown both in unclamped state in FIG. 23).

The further figures, which are discussed in more detail below, show other examples of a self-climbing tower crane, in particular in view of illustrating the fourth aspect of the invention. It will be appreciated that these figures and the discussion thereof also relate to features that are alone or in combinations applicable in the context of one or more of the other aspects of the invention, e.g. the first aspect of the invention, unless technically incompatible.

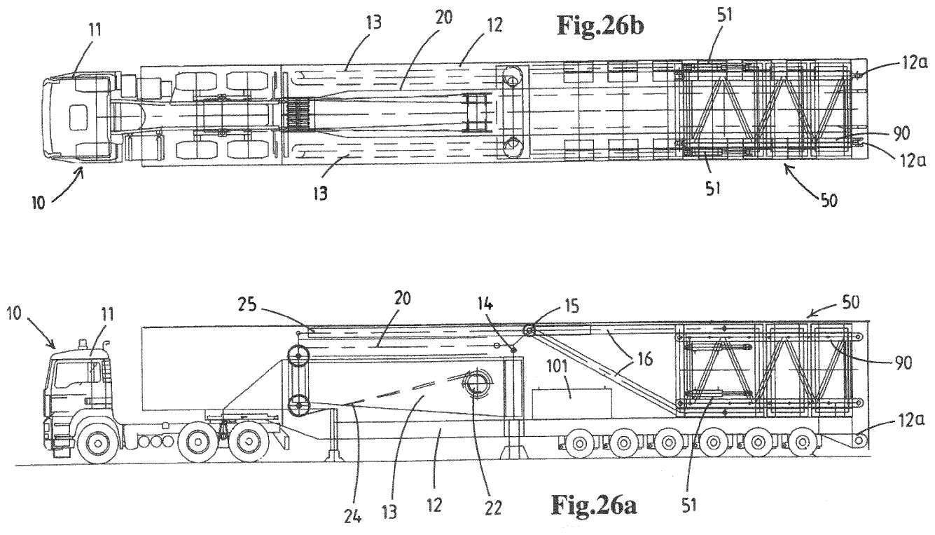

The FIGS. 26a, b show schematically, in a side view and from above, a first road vehicle 10 embodied as a semi-trailer truck with a tractor 11 and a multi-axis trailer 12, here embodied as part of the crane base of the crane. The trailer 12, as preferred in view of allowable height for road travel, is embodied similar to a low flatbed trailer so as to allow for optimum cross-section of the lifting unit 50 (to be discussed below) and thereby of the cross-section of the crane tower.

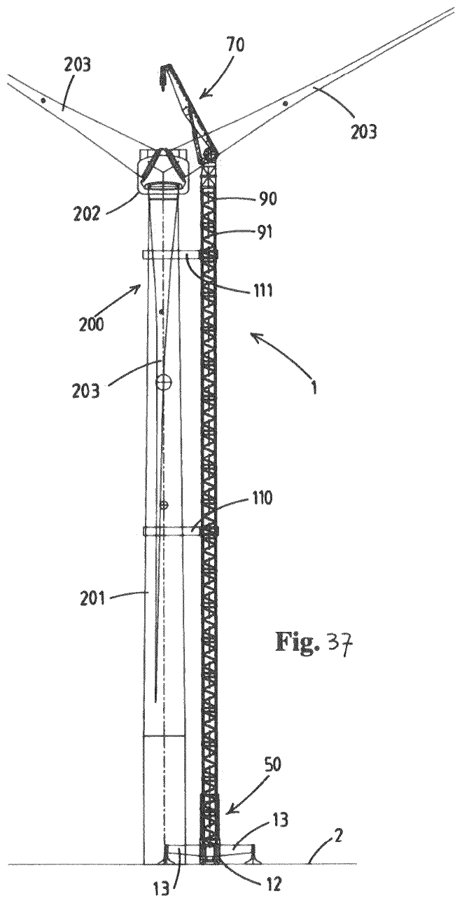

The trailer 12 is provided with deployable, here outward swinging, support struts 13 to stabilize the trailer 12 on a support, for example a hardstand (also referred to a pad or crane pad) at the hoisting site, e.g. in proximity and/or even on the foundation of an onshore wind turbine 200 (see e.g. FIGS. 37-39).

As will be discussed in more detail below, a crane tower lifting unit 50 is pivotally connected to the trailer 12 and is initially supported in a horizontal orientation thereon. Here the trailer 12 has at its forward end a support bracket 14 with a horizontal pivot axis 15 generally aligned with a side of the lifting unit 50.

A pedestal structure 16 may be present, as shown here, intermediate the pivot axis 15 and the lifting unit 50 in order to provide sufficient clearance for placing a new tower segment 91 underneath the vertically oriented lifting unit 50 during the crane tower assembly phase as this lifting unit 50 is configured for stacking a new tower segment underneath the already constructed crane tower when lengthening the crane tower.

The FIGS. 26a, b illustrate that a first crane tower segment 90 is initially retained in the lifting unit 50 as will also be discussed in more detail below.

The FIGS. 26a, b also show the presence of a pivotal upending frame 20 that is to be pivotally mounted to the trailer 12 at one end and has a free outer end. A winch driven cable pull mechanism is provided between the free outer end of the upending frame 20 and the trailer. In more detail, in this example, the trailer 12 is provided with an upending winch 22 which drives an upending cable 24 that extends in a multi-fall arrangement between a sheave set on the trailer 12 and a sheave set on the outer end of the upending frame 20. The FIGS. 26a, b also depict schematically the provision of one or more tensile members 25 that are to be connected between the upending frame 20 and the lifting unit 50 so that upon exerting a pull force by means of the winch driven cable 24, the interconnected lifting unit and jib unit, which is still to be discussed, are upended. In another embodiment, one or more hydraulic cylinders are provided as pivoting actuator mechanism, mounted between the trailer 12 and the lifting unit 50.

The total length of the road vehicle 10 as depicted can be over 20 meters, e.g. about 25 meters.

For example, the trailer 12 with the lifting unit 50 thereon as depicted has a width of about 3 meters and a height of about 4.1 meters.

The total weight of the road vehicle 10 as depicted can be over 50 tonnes, e.g. about 75 tonnes, e.g. with about 15 tonnes load on the kingpin and a load of about 10 tonnes per axle of the multi-axis trailer 12.

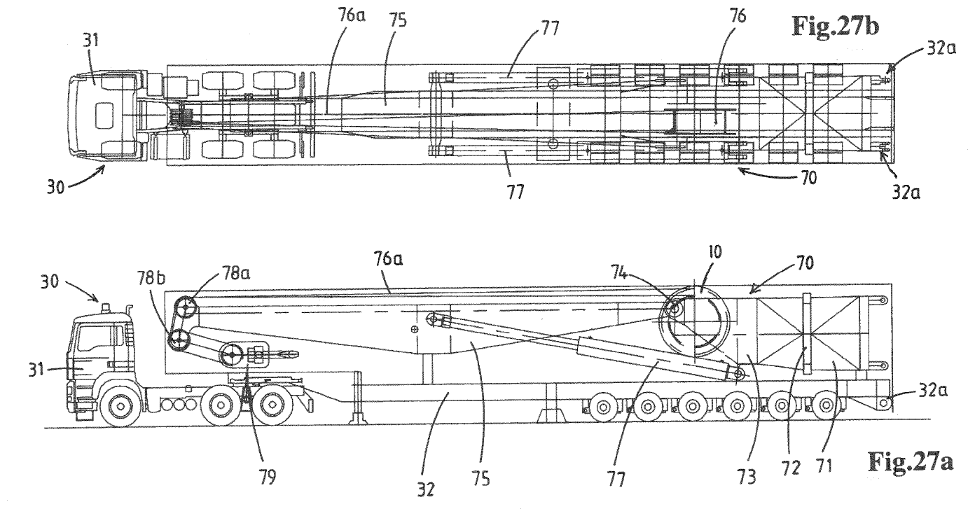

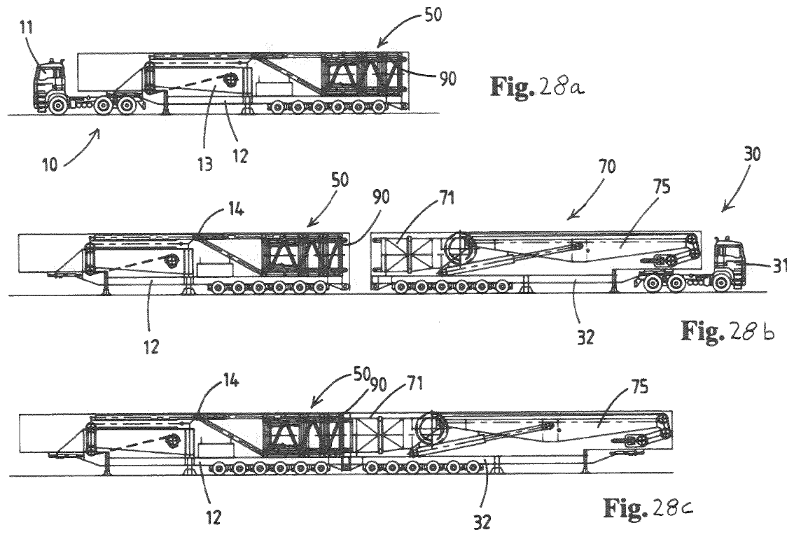

The FIGS. 27a, b show schematically, in a side view and from above, a second road vehicle 30 embodied as a semi-trailer truck with a tractor 31 and a multi-axis trailer 32, The second road vehicle 30 is used to transport the slewable jib unit 70 loaded in horizontal orientation on the trailer 32 to the hoisting site. As preferred, and as will be discussed below, the second trailer 32 is also embodied as part of the crane base of the crane.

The jib unit 70 comprises a slew bearing 72 mounted between a lower jib unit structure 71 that is to be connected to a crane tower segment (as will be discussed in more detail below) and an upper jib unit structure 73. A slew drive is present as well.

The jib unit 70 further comprises a jib 75 that is pivotally mounted to the upper jib unit structure 73 about a jib pivot axis 74. In this example, two hydraulic cylinders 77 form part of the jib luffing mechanism which is configured to luff the jib 75 up and down. The jib unit 70 further comprises a hoist winch 76 and associated hoist cable 77a which runs over sheaves 78a,b of the jib 75 to a travelling block 79 of the crane, here with a swivelling hook.

In the transport situation the jib 75 lies generally horizontally on the road vehicle, here trailer 32.

As preferred, the jib 75 is a rigid jib lacking articulation.

As preferred, the jib is a box type jib.

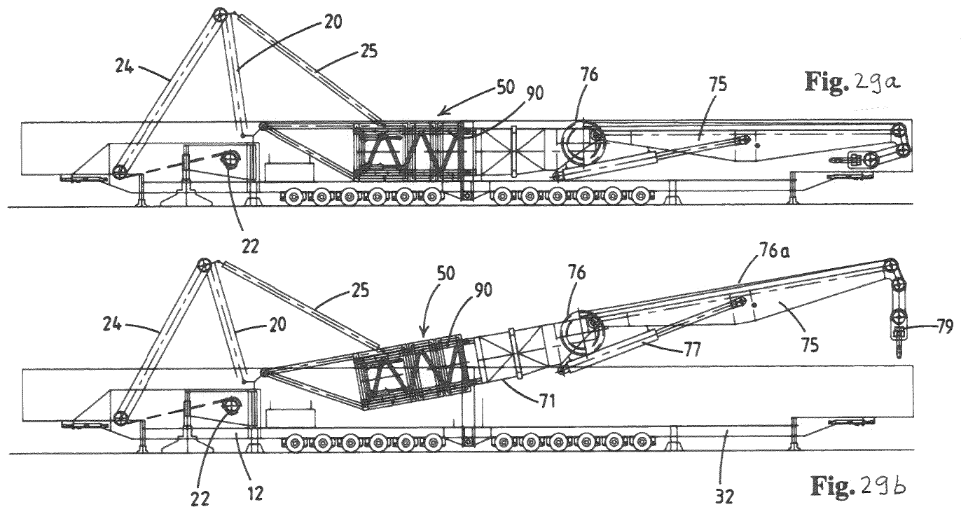

The FIG. 28a illustrates the parking of the first road vehicle 10 at the hoisting site and the deployment of any stabilizing struts. For example, as shown in FIGS. 37-39, the trailer 12 is parked on a hardstand in close proximity to a wind turbine that is to be (dis-) assembled and/or completed and/or subject to maintenance. As follows from FIG. 28b, the tractor 11 can be disconnected from the trailer 12.

The FIG. 28b illustrated the manoeuvring of the second road vehicle 30 in alignment with the trailer 12 of the first road vehicle 10. As shown, it is envisaged that the top of the still horizontally oriented lifting unit 50 is at the rear of the trailer 12 and the lower end of the jib unit 70 is at the rear of the trailer 32. This allows to back-up the vehicle 30 to bring the jib unit 70 close to the lifting unit 50.

FIG. 28c illustrates that act of interconnecting of the slewable jib unit loaded on the trailer 32 of the second road vehicle 30 with the lifting unit 50 still horizontal on the trailer 12 of the first road vehicle 10 prior to upending.

In more detail, a first or upper tower segment 90 is already retained initially in the lifting unit 50, and the lower jib unit structure 71 is provided with connectors allowing to connect the jib unit 70 to the upper end of the first tower segment 90. This effectively connects the jib unit, via the tower segment 90, to the lifting unit 50. In another approach, a direct temporary connection is provided between the jib unit 70 and the lifting unit 50 prior to upending, or such direct connection is provided in addition to the connection to the upper tower segment 90.

FIG. 28c also depicts the preferred approach wherein the trailers 12, 32, each forming part of the crane base, are mechanically connected so as to form a rather long, e.g. over 30 meters long, rigid component of the crane base. Herein the chassis, here of trailers 12, 32, of both road vehicles 10, 30 are connected via mechanical connectors 12a, 32a, here at their rear ends. The latter allows to obtain a large and stabile crane base, e.g. in view of the upending of the interconnected lifting unit and jib unit as will be discussed below.

In FIG. 29a it is illustrated that the upending frame 20 is deployed so that the outer end is well above the pivot axis. The outer end of the frame is secured via one or more tensile members to the lifting unit 50. The winch driven cable 24 is arranged between the outer end of the frame 20 and the trailer and is driven by winch 22.

The FIG. 29b demonstrates the start of the upending step. Upon exerting a pull force by means of the pull mechanism, the interconnected lifting unit 50 and jib unit 70 start to be upended. This requires significant upending torque provided by the winch 22. The rigidly connected trailers 12, 32 effectively provide a stable platform during upending.

In an embodiment, a ballast is (temporarily) placed on the crane base, e.g. on the first road vehicle, e.g. on trailer 12, to stabilize the crane base in particular for the upending phase. For example, the crane base is provided with water ballast tanks that can be filled at the hoisting site.

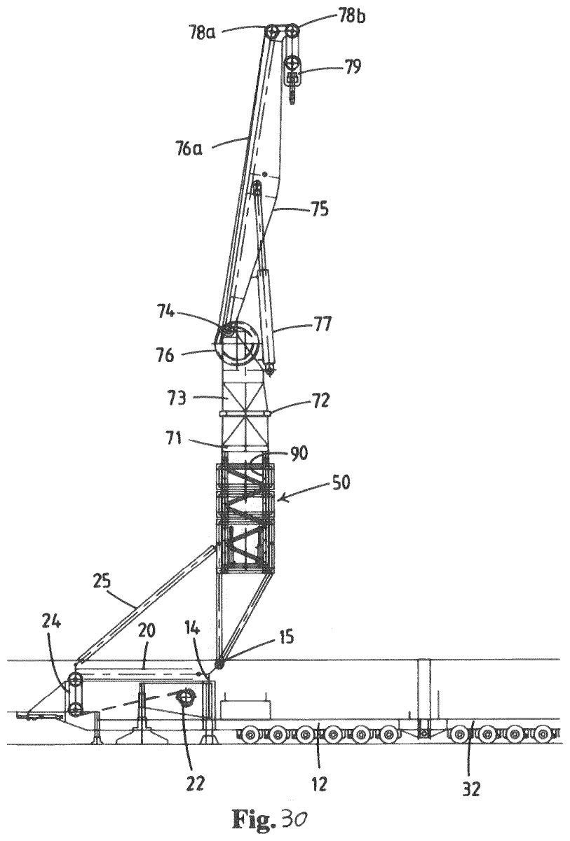

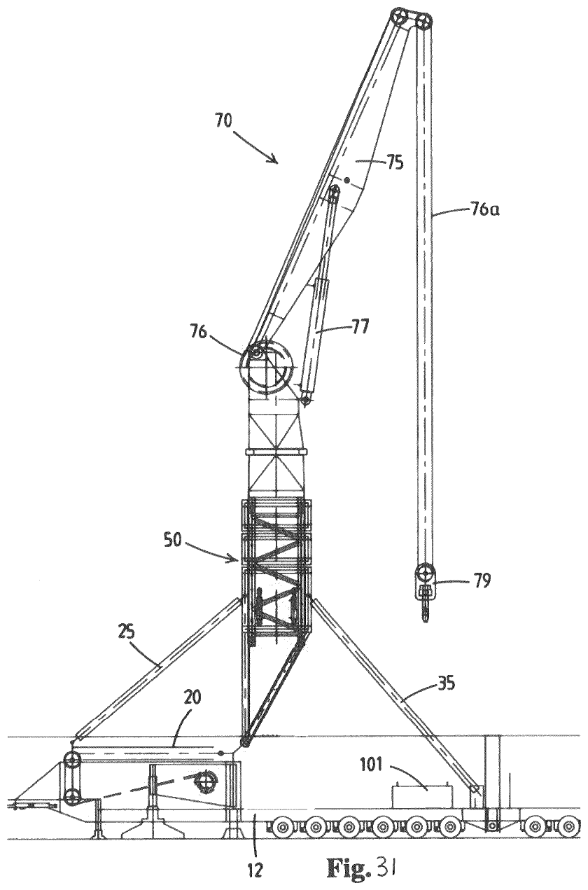

FIG. 30 shows that the upending step is completed. The interconnected lifting unit 50 and jib unit 70 are now vertically oriented. The luffing mechanism has held the jib 75 extended during this process, as is preferred.

It will be appreciated that the approach illustrated with reference to FIGS. 28a-c, 29a, 29b does not require the use of any auxiliary crane, or at least not of any sizable crane as in the prior art. Also there is no need for additional hardstand area for any such sizable auxiliary crane to stand during this initiation of the tower crane. Furthermore working a height of personnel is generally not required in this initiation phase, again in contrast to the mentioned prior art approaches.

As preferred, the jib unit 70 is fully outfitted before the upending takes place. For example, the entire jib 75 is part of the jib unit 70 that is to be upended, with no need to add one or more jib sections to the jib 75 that is connected to the upper part 73. This avoids the use of a sizable auxiliary crane as in the prior art approaches wherein the jib is assembled at significant height above the ground as a part of the crane tower has already been erected.

As depicted, the jib unit 70 is devoid of counter ballast, which is preferred in view of the upending loads. In another embodiment, counter ballast can be provided on the jib unit, e.g. to be installed later, e.g. by means of the hoisting winch system of the jib unit 70 itself.

The FIG. 31 shows that, after completion of the upending step, one or more stabilizing frame members 35 are arranged between the crane base, here the trailer 12, and the upended lifting unit 30.

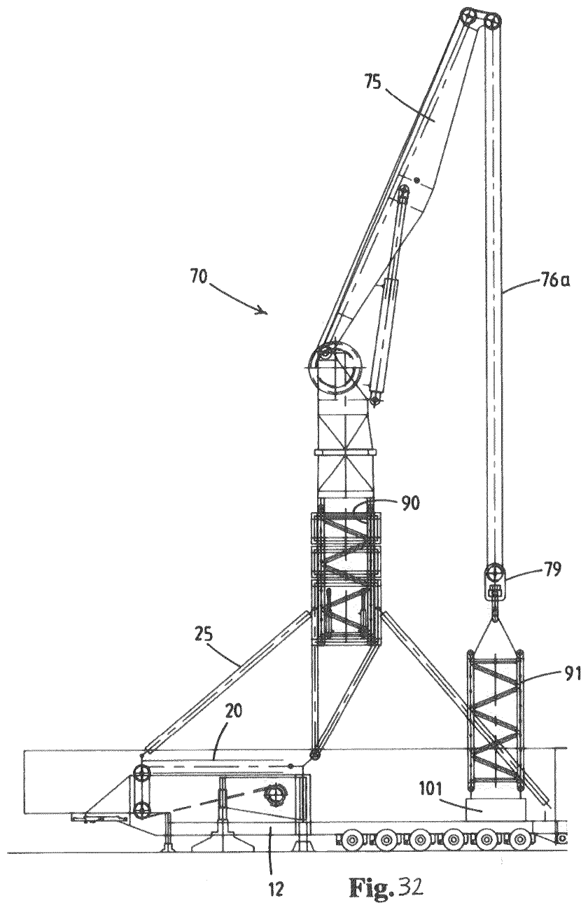

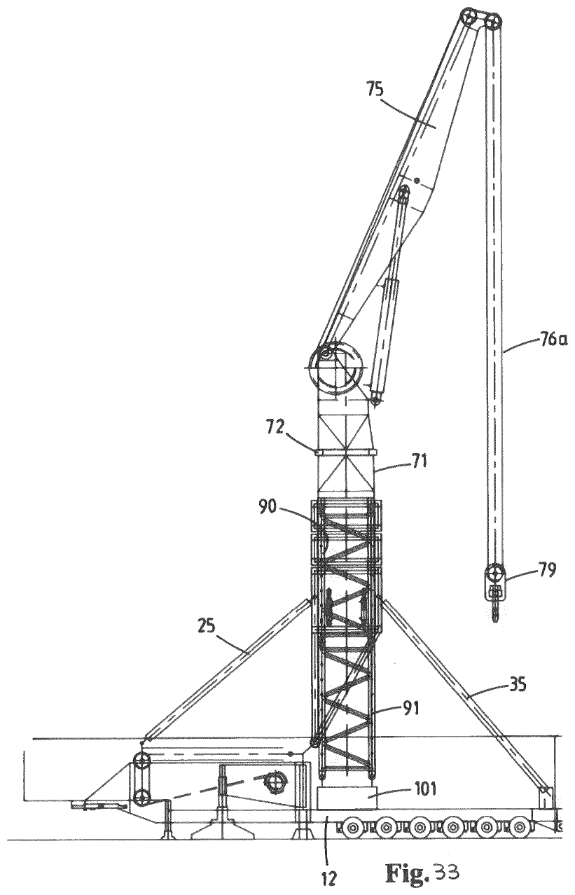

The FIGS. 32 and 33 illustrate the handling of a crane tower segment 91 by means of the jib unit 70. In FIG. 32 this tower segment 91 is placed on a tower segment handling device 100 that is mounted on the road vehicle 10, here on the trailer 12. For example, as shown schematically, the device 100 comprises a cart 101 that is movable over rails of the device, e.g. in longitudinal direction of the trailer 12 between the second position thereof shown in FIG. 32 and the first position thereof shown in FIG. 33. The tower segment 91 is placed in vertical orientation on the cart 101 by means of the jib unit 70, e.g. the jib unit being used to first lift the segment 91 from a transport vehicle and then placing the segment on the cart 101. The cart 101 is then shifted, so that the segment 91 becomes arranged underneath the lifting unit 50.

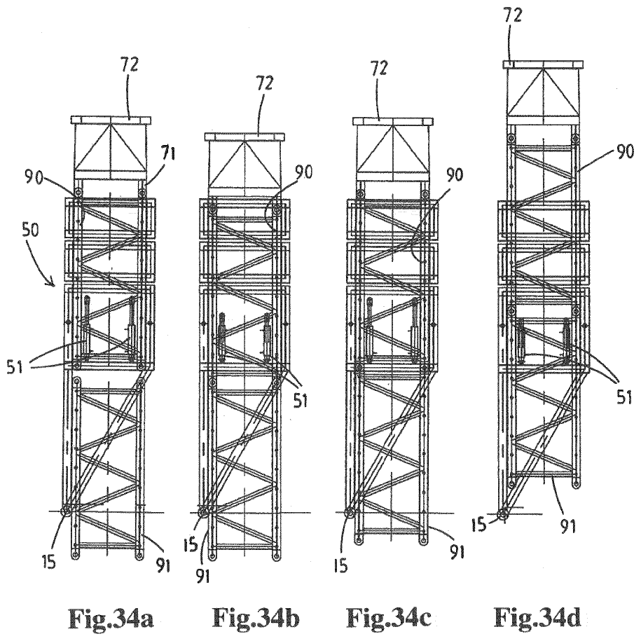

The FIGS. 34a-d illustrate, by way of example, the operation of the lifting unit 50. The situation of FIG. 9a corresponds the segment 91 just being shifted to underneath the lifting unit 50. The upper tower segment 90, on which the jib unit 70 is mounted, is now spaced vertically from the segment 91.

In FIG. 34b, the lifting unit 50 is operated to lower the segment 90 so that the connectors of the segments 90, 91 are connectable, e.g. via pins to be introduced through aligned holes in tabs on the corners of the segments 90, 91, e.g. at the ends of the main chords of the segment.

The lifting unit 50 is provided with hydraulic operated lifting actuators 51 to controllable lift and lower the segment of the crane tower that passes through the lifting unit 50.

In FIG. 34c, after the connection between the segments 90, 91 has been made, the still rather short crane tower with the jib unit 70 thereon is lifted by means of the actuators 51 in a stepwise process, as is further depicted in FIG. 9d. After each stroke of the actuators 51, a locking mechanism of the lifting unit retains the crane tower, allowing the actuators 51 to retract in order to allow for a next stroke. This process is repeated until the situation of FIG. 9a is achieved, allowing to add another segment to the crane tower. This effectively is stacking segments underneath one another to lengthen the crane tower.

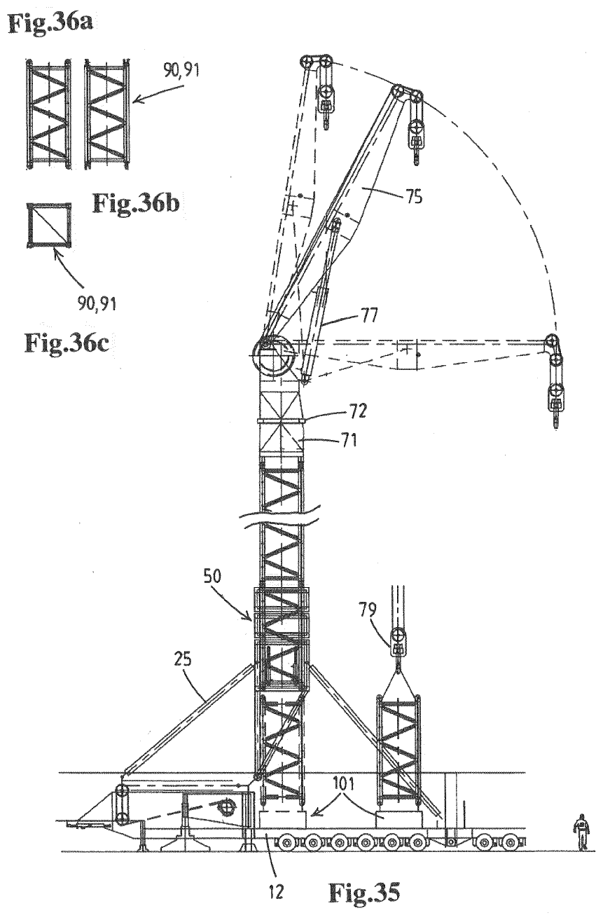

The so-called crane tower assembly phase is continued until the crane tower has reached it desired height. This is depicted in FIG. 35.

The FIGS. 36a-c show the crane tower segment 90 in side views and in top view. Generally, each segment 90 is embodied as a latticed structure with main chords at the corners and (diagonal) bracing between adjacent chords. Connectors are provided at the ends of the chords.

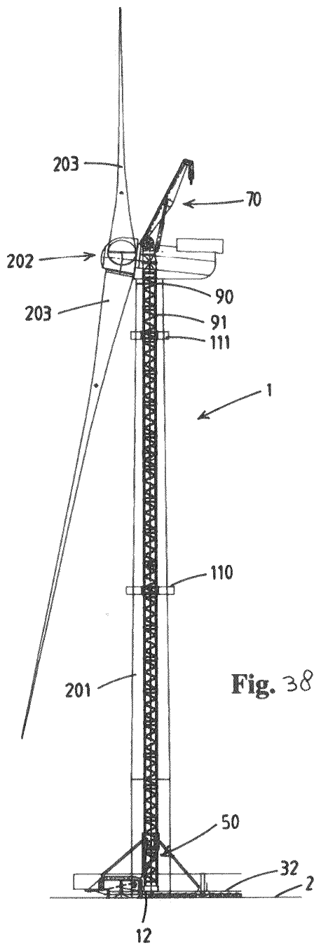

As discussed, the crane 1 of FIGS. 26-36 can be erected alongside a wind turbine 200 shown in FIGS. 37 and 38. As is known in the art, along the height of the crane one or more guy arrangements 110, 111 can be provided that connect the crane tower to the mast 201 of the wind turbine 200. For example, the crane tower has a height of more than 100 meters, e.g. of more than 130 meters.

As shown in FIGS. 37, 38 the crane can be assembled such that the jib unit 70 is at of even above the top of the mast 201, e.g. allowing for hoisting of a component of the nacelle 202 or of a wind turbine rotor blade 203 using the crane.

As shown in the plan view of FIG. 39, the crane base, here the first and second trailers 12, 32, can be parked in close proximity of the foot of the mast 210, e.g. with a spacing between the center of the mast 201 and of the crane tower of between 6 and 10 meters.

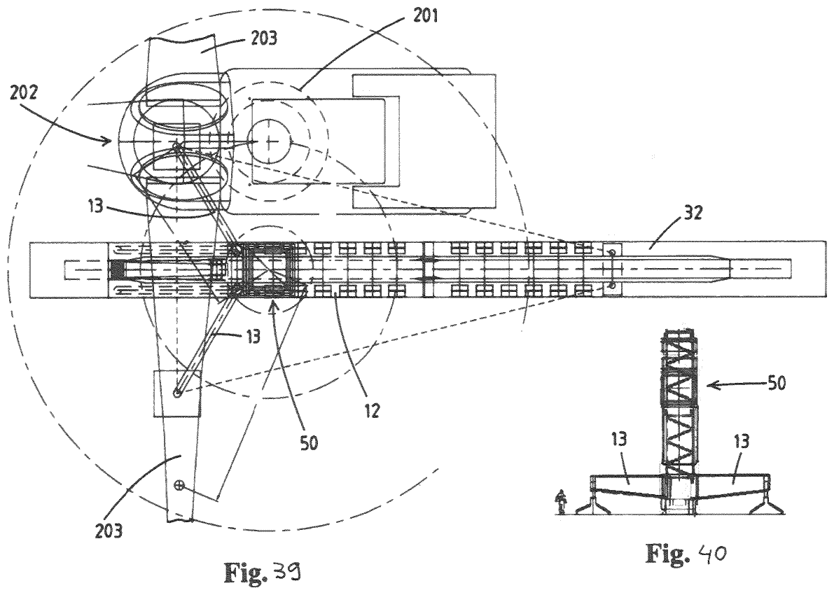

FIGS. 39 and 40 show that folding struts 13 on the trailer 12 can be deployed outward from the sides of the trailer 12 so as to stabilize the tower crane on the hardstand 2 or pad adjacent the foot of the wind turbine mast 201.

Whilst it is preferred to integrate at least at part of the crane base with a road vehicle, e.g. a trailer 12, it is also envisaged that a part of the crane base is offloaded from a road vehicle at the hoisting site and installed directly on the support. For example, the crane base (or part thereof) is installed on the foundation of the wind turbine, e.g. bolts temporarily securing the crane base to the foundation of the wind turbine mast.

Whilst it is preferred to transport at least a part of the crane base as well as the lifting unit with a single road vehicle, e.g. on a trailer 12, one can also envisage the use of multiple, e.g. two road vehicles for transport of these main components of the crane to the hoisting site. Then an assembly step will be required to connect the crane base and the lifting unit. One can envisage that a routine similar to the routine illustrated with reference to FIGS. 28a-28c is used to connect the lifting unit to the crane base. One can also envisage that the crane base is offloaded from the one road vehicle, e.g. to be secured to the wind turbine foundation, and then the lifting unit is transported with another vehicle, wherein the lifting unit remains horizontally on the other vehicle while the connection is made to the crane base. Other approaches to arrive at the assembly in its initiation state as discussed herein are also possible.

Whilst it is preferred to use a lifting unit 50 that remains stationary at the lower end of the crane tower, the inventive concept also allows for the known embodiment of the lifting unit which remains directly underneath the jib unit and thus moves up with the lengthening of the crane tower.

With reference to FIGS. 41-46 in particular, an embodiment of the invention will now be discussed wherein for upending the interconnected lifting unit and slewable jib unit use is made of an auxiliary mobile crane 300.

In a common embodiment, the crane 300 is embodied as a road vehicle with a chassis 303 on which a slewable crane housing 301 with a luffable and telescopically extendable crane boom 302 is arranged. As shown, the chassis may be provided with deployable ground-engaging supports 304 to stabilize the crane 300.

Due to the use of an auxiliary crane 300, the first road vehicle 10′ shown in FIGS. 41a,b, 42a, b, etc, does not need to have upending mechanism as discussed with reference to the embodiment of FIGS. 26a,b, etc.

The vehicle 10′ has the trailer 12′ with thereon the crane tower lifting unit 50. This unit 50 is pivotally connected to the trailer 12′ and is initially supported thereon in horizontal orientation. Here the support bracket 14 of the trailer 12′, to which the unit 50 is connected via pedestal 16 and the horizontal pivot axis 15, is mounted at the rear of the trailer 12′.

A first crane tower segment 90 is initially retained in the lifting unit 50.

It is shown that the trailer 12′ has been parked with its rear in close proximity to the foot of the wind turbine mast 201 on a hardstand. The solid circle and dashed line circle indicate various diameters that the foot of the mast 201 may have.

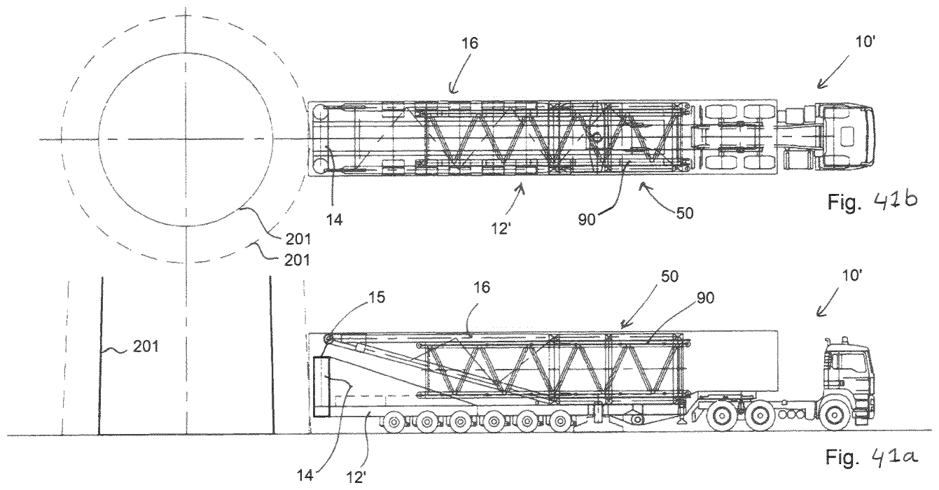

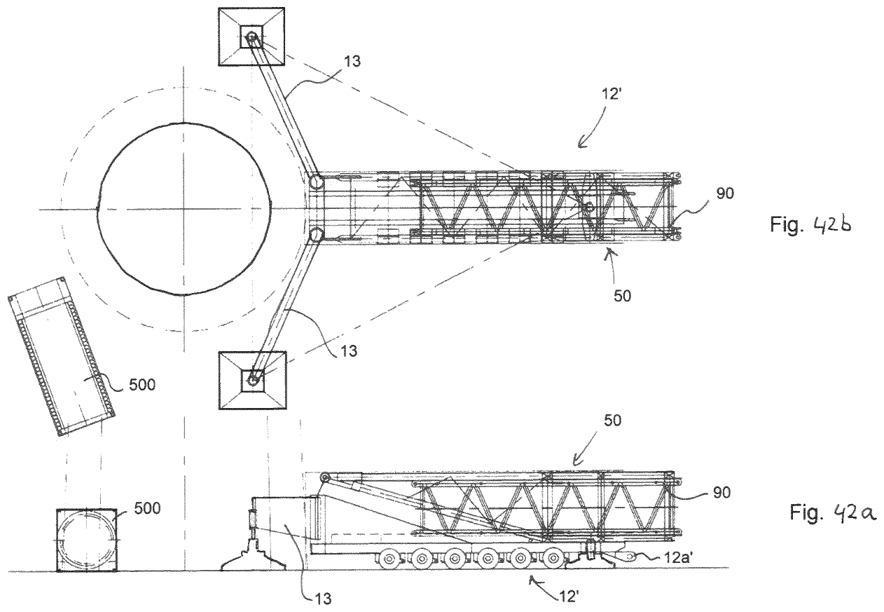

In FIGS. 42a, b the support struts 13 of the trailer 12′ are deployed, and the tractor of the first road vehicle has been moved away from the parked trailer 12′. It is shown that the top end of the unit 50 and of the first crane tower segment 90 are accessible for connection of the jib unit 70 that is to be transported to the site using a second road vehicle 30.

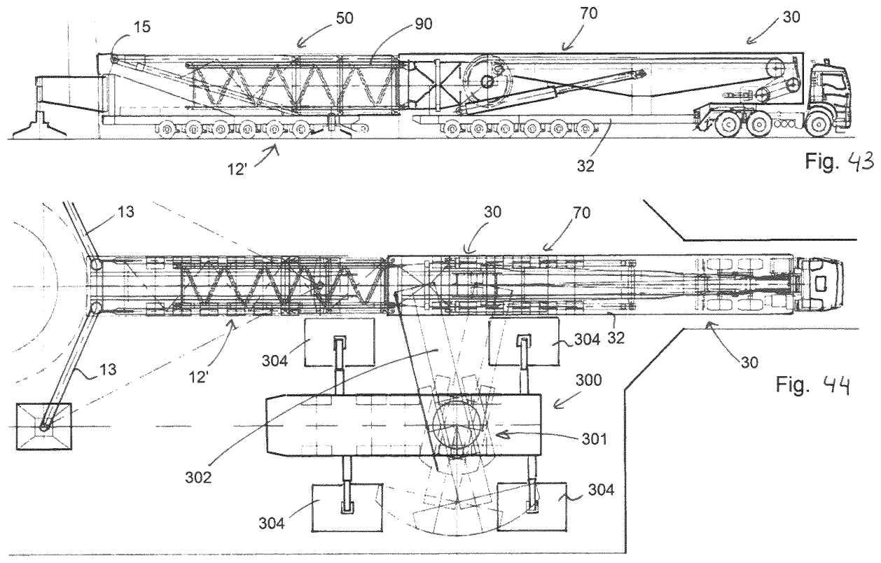

FIG. 43 illustrates that the second road vehicle 30 carrying the jib unit 70 is manoeuvred in alignment with the trailer 12′. The rear of the trailer 32 is directed to the trailer 12′ so that the jib unit 70 can be connected to the top end of the segment 90. This is shown in FIG. 43.

As shown in FIG. 44, the auxiliary crane 300 is to be stationed in proximity and along the side of the aligned trailers 12′, 32, e.g. with the slewable crane housing 301 near the join between the segment 90 and the jib unit 70.

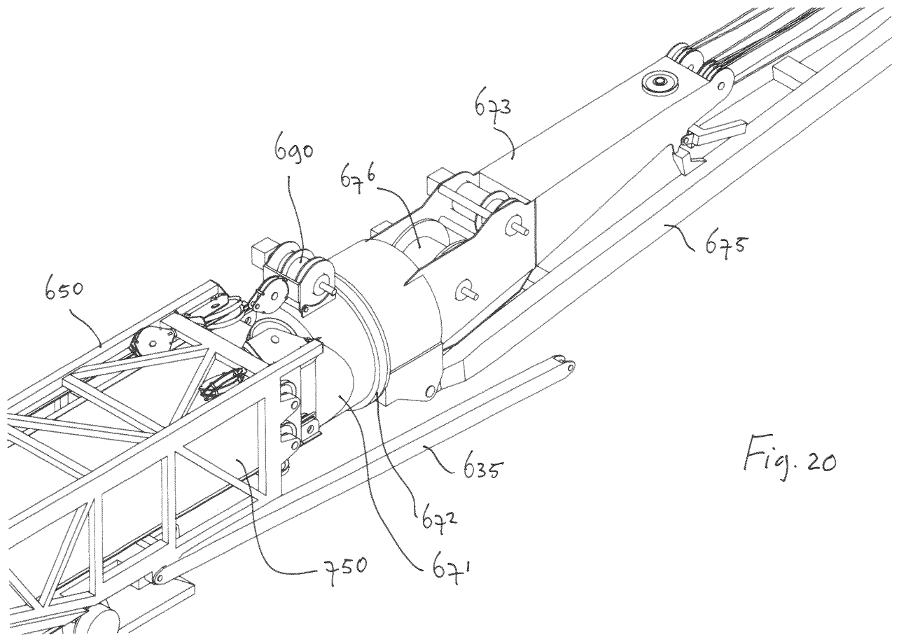

The first stage of the upending of the interconnected lifting unit 50, with segment 90, and slewable jib unit 70 using the auxiliary mobile crane 300 is illustrated in FIGS. 20a, b.

The crane 300 has crane hook 305 that is connected to the jib unit 70, e.g. in proximity of the winch thereof. Then the interconnected assembly is tilted upwards by lifting the crane hook 305, with the jib 75 of the unit 70 remaining in its “vertical” position as the cylinders 77 remain extended. So, the entire interconnected assembly is subject to a first stage of the upending. The jib unit 70 is so lifted from the trailer 32 of the second road vehicle 30.

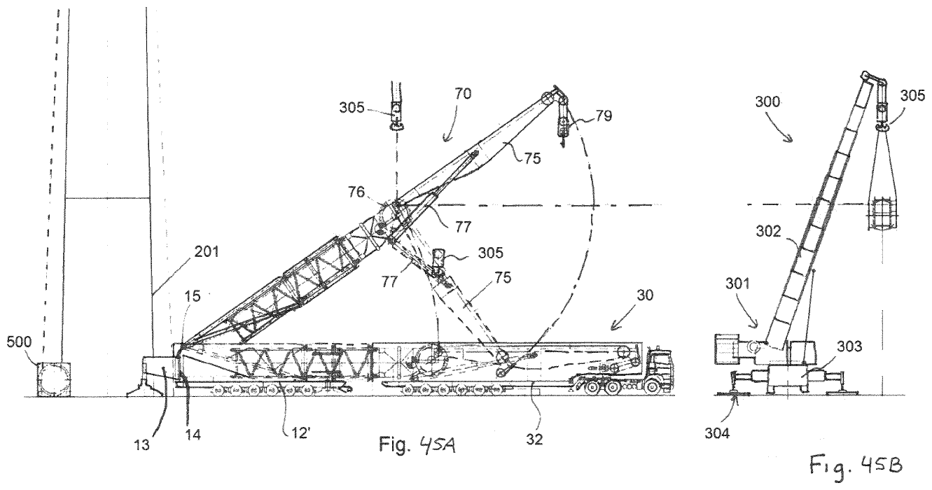

At the end of the first stage, with the assembly remaining suspended from the crane 300, the jib 75 is pivoted to its “horizontal” position by retracting of the cylinders 77. This is shown in FIG. 45a. The FIG. 20b shows that the crane 300 holds the assembly in the position that allows for the pivoting of the jib 75.

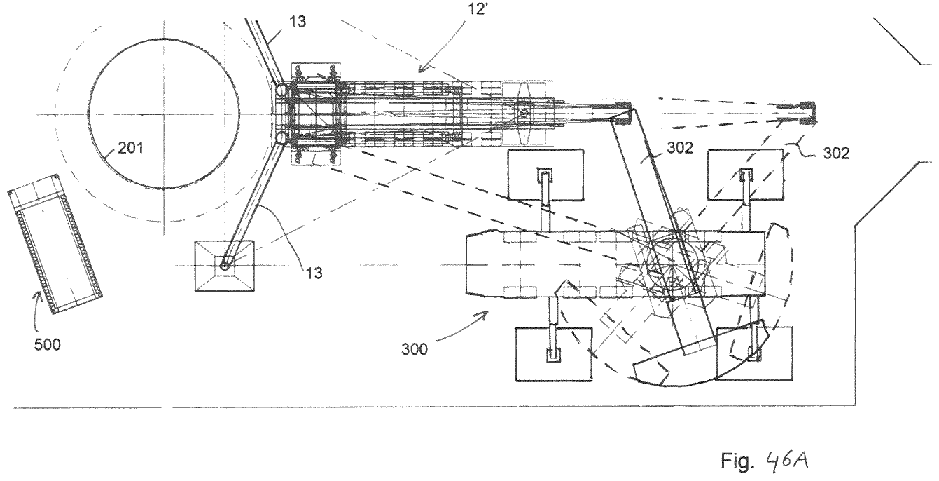

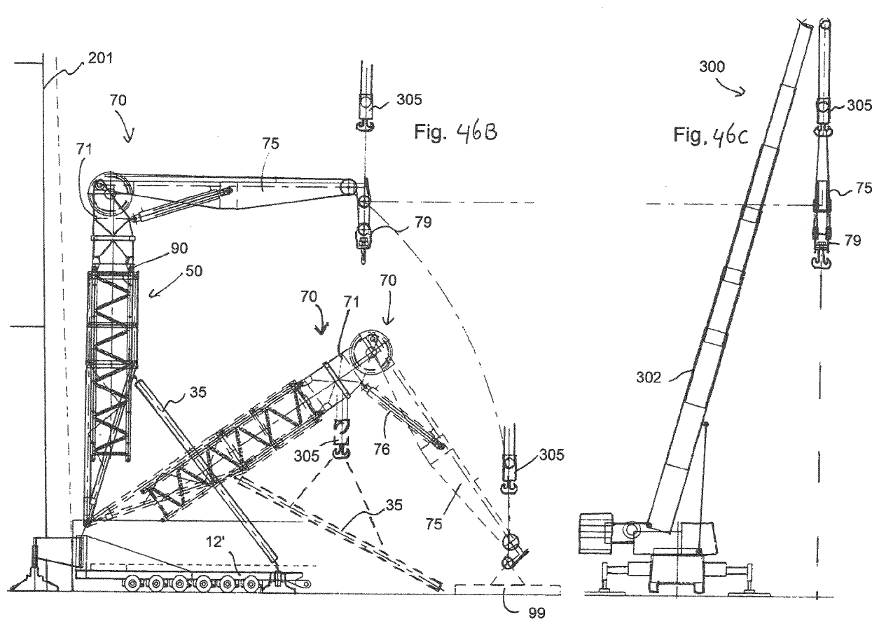

The first stage is also depicted in FIG. 46a.

The second road vehicle 30 is now removed, allowing to rest the jib unit 70, in particular the end of the boom 75, on the ground or a temporary support 99.

Now the crane hook 305 is disconnected from the lower jib unit structure 71 and is the connected to the boom, preferably near or at the end of the boom 75, which is shown in FIG. 46b. This forms the start of the second stage.

In the second stage, the crane 300 is operated to hoist to further upend the assembly until the unit 50 is vertical as is shown in FIG. 46b.

A stabilizing frame member 35 is used to stabilize the unit 50 in vertical position. As shown, the crane 300 may be used to, before being connected to the boom 75, bring the member 35 in a position wherein one end thereof can be connected to the unit 50. During the subsequent second stage upending, this member 35 then becomes arranged between the unit 50 and the trailer 12′. The lower end of the member 35 is then connected to the trailer 12″. Alternative stabilizing structures are also possible between the unit 50 and the trailer 12′.

Now the upending is completed. The next phase is the crane tower assembly phase. Generally, the same approach to erecting of the crane tower is used as in the preceding embodiment.

As the crane 300 is available, the handling of new crane tower segments 91 may be done with the auxiliary crane 300 instead of using the jib unit 70.

The boom 75 is tilted into its vertical position.

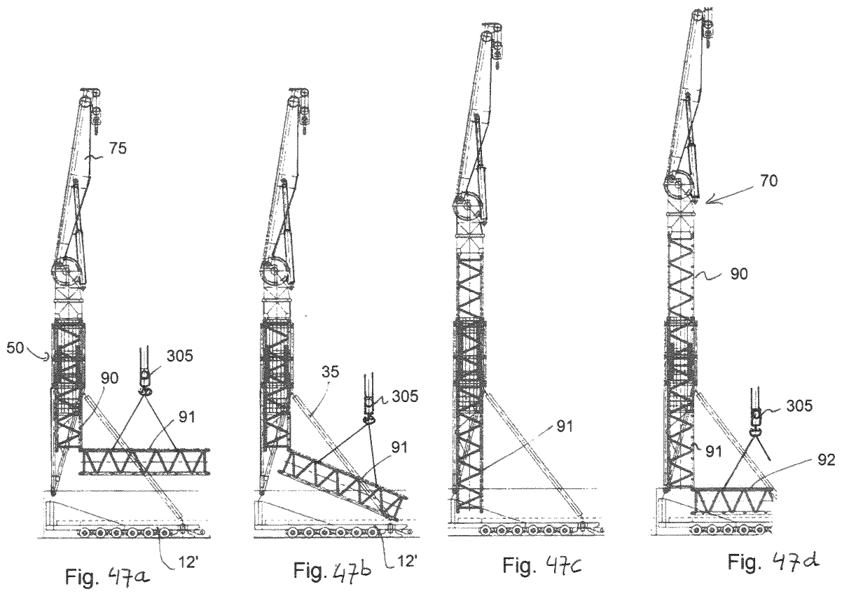

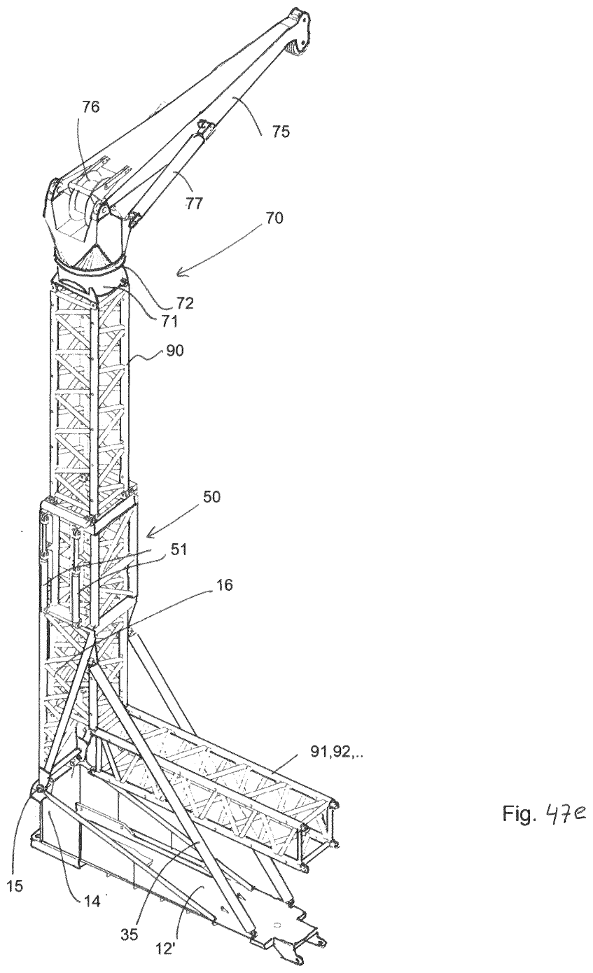

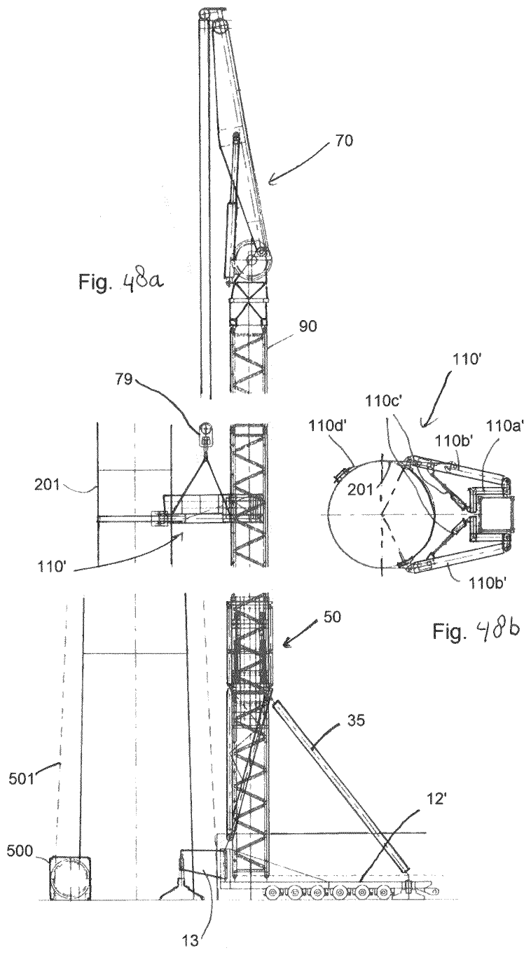

The crane 300 advances a new segment 90 so that the upper end thereof is connectable to the lower end of the segment 90. As shown in FIGS. 47a-c some lifting of the crane tower segment 90 may be involved to create sufficient space underneath the segment 90 to bring the new segment 91 into vertical orientation. Of course this will depend on the geometry of the actual components of the inventive tower crane.

FIG. 47d the illustrates that stacking tower segments, here segment 92, one-by-one underneath the already construed crane tower creates a crane tower of desired height.

As the height of the crane tower may well be significant it is envisaged that one or more guy arrangements 110′, also called stabilizer devices in the context of the FIGS. 1-25, are placed along the height of the mast 201 and connect the crane tower to the mast 201.

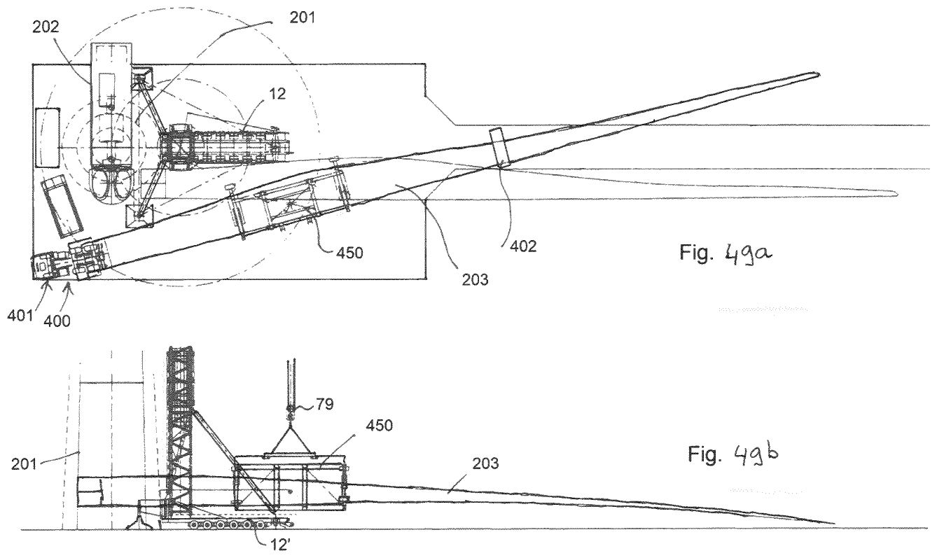

It is illustrated in FIG. 48a that the jib unit 70 may be employed to lift these one or more guy arrangements 110′ to the desired height along the mast 201.

The guy arrangement 110′ may be fastened to a crane tower segment that is present above the unit 50, e.g. using the jib unit 70 or an auxiliary crane, and the continued extension by stacking of the crane tower may then cause the arrangement 110′ to be moved to the desired height along the mast 201.

For example, as shown FIG. 48b, a guy arrangement comprises a frame 110a′ that is configured to be mounted to the crane tower, e.g. U-shaped when seen from above.

The frame 110a′ may support two pivotal arms 110b′, that have one end pivotally connected to the frame 110a′ about a vertical pivot axis. The other end of the arms 110b′ has a pad to support the arm end against the exterior of the mast 201. Pivoting and positioning of the arms 110b′ may be done with an actuator system, e.g. a cylinder 110c′ for each arm as shown.

The guy arrangement 110′ may, in addition to the arms 110b′ comprises a mast encircling assembly 110d′, for example a strap or rope, or the like, that encircles the mast 201 opposite the location where the arms 110b′ rest against the mast. For example, the strap or rope is connected to the arms 110b′, e.g. one end of the strap or rope being fixed and the other end of the strap or rope being connected to a tensioning device, e.g. a winch.

For example, the strap 110d′ or other encircling assembly is already fitted around the mast 201 when the guy arrangement 110′ is at a low level along the mast. Then the arrangement 110′ is lifted up along the mast 201 with the strap or the like in loose configuration, e.g. the lifting being cause by extension of the crane tower via stacking as discussed herein. Once the arrangement 110′ is at the desired height along the mast 201, the strap or the like is tensioned.

Other guy arrangements 110′ may be used as well.

FIGS. 49a, b illustrate how the tower crane of FIGS. 41-48 can be used for handling a wind turbine rotor blade 203.

In FIG. 49a a special long load road vehicle 400, with a tractor 401 and a rear wheel set 402 is parked close to the tower crane. The vehicle 400 carries the blade 203.

A blade lifting tool 450 is suspended from the crane hook 79 and is connected to the blade 203. The tower crane is then operated to hoist the blade 203, whilst remaining horizontal as preferred, to the height of the nacelle 202 of the wind turbine.

In embodiments, the nacelle 202 is oriented such that the mounting axis for the blade 203 is parallel to the trailer 12′ as shown in FIG. 49a. This allows for effective handling and installation of the blade 203 using the tower crane.

In practical embodiments, the weight of a complete nacelle including housing, as well as hub part, gearbox (if present), and generator part, may exceed the hoisting capacity of the tower crane.

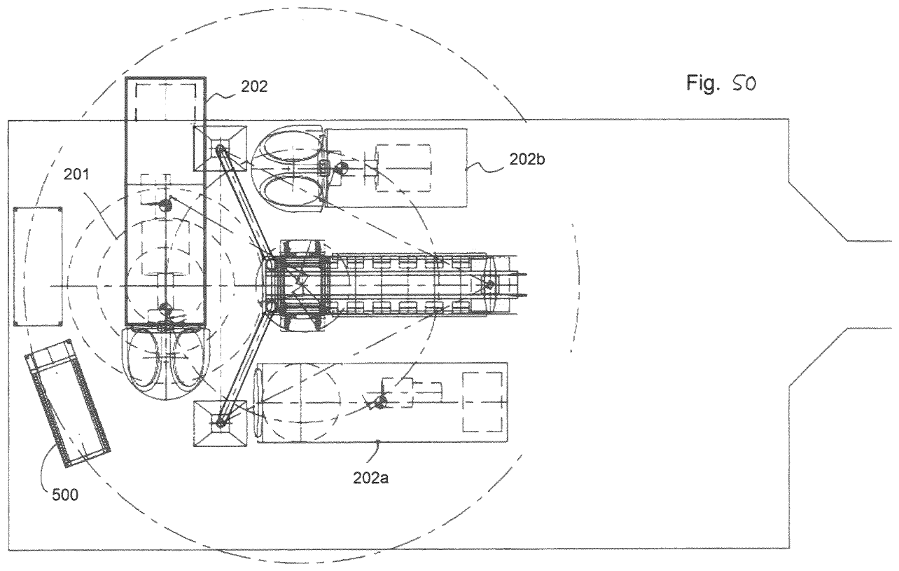

FIG. 50 illustrates schematically, that the housing 202a, which may include some equipment, is one component to be handled by the tower crane, and that another component 202b includes the hub part, gearbox (if present), and generator part. Both components are then of a weight that can be handled by the tower crane. In embodiments, the distribution of parts over the two components to be lifted is different, e.g. the generator already being part of the housing component 202a.

The figures also show that in embodiment one or more umbilical winches 500 can be arranged in proximity of the foot of the mast 201. The winch 500 carries one or more umbilical lines 501 that are hoisted up to the nacelle 202, e.g. for use in testing operations, for use in installation of the blades 203, powering and/or (remotely) controlling the slewable jib unit, the stabilizer devices, etc.

1. A self-climbing tower crane which is configured to be arranged on a support at a hoisting site, wherein the tower crane comprises:
a crane base configured to be placed on the support at the hoisting site;
tower segments which are configured to be stacked onto one another from below in order to erect a crane tower which is composed of the tower segments on the crane base;
a crane tower lifting unit mounted on the crane base and configured to perform lifting actions in the process of stacking of the tower segments, wherein the crane tower lifting unit stepwise lifts the crane tower from below; and
a slewable jib unit configured to be mounted on top of the crane tower, wherein the tower crane is configured to, with the slewable jib unit connected to an upper tower segment, erect the crane tower by stacking the tower segments onto one another from below to lengthen the crane tower under the slewable jib unit,
wherein the crane tower comprises an upper section to be composed of a series of multiple upper tower segments and a lower section to be composed of a series of multiple lower tower segments, the lower section being configured to support the upper section thereon,
wherein each upper tower segment is embodied as a tubular girder type tower segment having a height and having an outer peripheral wall of steel plate, as well as upper and lower end portions provided with connectors to rigidly interconnect the upper tower segments,
wherein each lower tower segment embodied as a latticed structure type tower segment having a height, having a main chord at each corner, and bracing between adjacent main chords, wherein the main chords are provided at ends thereof with connectors to rigidly interconnect the lower tower segments,
wherein the tower crane further comprises an upper stabilizer device and a lower stabilizer device, each configured to horizontally connect the upper section of the crane tower to an external tall structure.

2. The tower crane according to claim 1, wherein the outer peripheral wall of steel plate of each upper tower segment is internally reinforced by longitudinal stiffeners extending along a height of the peripheral wall.

3. The tower crane according claim 1, wherein one or more diaphragm plates are present inside each upper tower segment.

4. The tower crane according to claim 1, wherein each upper tower segment has a height of at least 6 meters.

5. Tower The tower crane according to claim 1, wherein the height of the upper section is at least 10% of the height of the crane tower.

6. The tower crane according to claim 1, wherein the height of the upper section is at least 25 meters.

7. The tower crane according to claim 1, wherein at least the upper stabilizer device is configured to travel up and down along the upper section.

8. The tower crane according to claim 1, wherein each of the lower and upper stabilizer devices is configured to travel up and down along the upper section.

9. The tower crane according to claim 1, wherein the upper tower segments are each provided with at least one guide rail extending along the height of the upper tower segment such that guide rails of the interconnected upper tower segments form a substantially continuous guide rail, wherein at least the upper stabilizer device is configured to travel up and down along the continuous guide rail of the upper section.

10. The tower crane according to claim 7, wherein the crane is provided with an upper stabilizer hoist device configured to hoist the upper stabilizer device along the upper section.

11. The tower crane according to claim 10, wherein the upper stabilizer hoist device is configured to provide a constant lift force mode allowing to suspend the upper stabilizer device from the upper stabilizer hoist device with a constant lift force allowing for the upper stabilizer device to be stationary relative to the tall external structure whilst the crane tower is extended.

12. The tower crane according to claim 1, wherein the lower and upper stabilizer devices are configured to engage on a wind turbine mast.

13. Tower The tower crane according to claim 12, wherein the lower and upper stabilizer devices are each configured to frictionally engage on a wind turbine mast.

14. The tower crane according to claim 1, wherein multiple of the lower tower segments are embodied as telescopic latticed tower segment assemblies, each composed of an outer lower tower segment and an inner lower tower segment which is slidably mounted in the outer lower tower segment between a retracted position and an extended position,
wherein each of the inner and outer lower tower segments is embodied as a latticed structure type lower tower segment having a height, having a main chord at each corner, and bracing between adjacent main chords, and
wherein the inner and outer lower tower segments are provided with locking members configured to lock the inner lower tower segment in the extended position thereof relative to the outer lower tower segment, and wherein the inner lower tower segment is provided with connectors to connect the inner lower tower segment to an outer lower tower segment of another telescopic latticed tower segment assembly, and wherein the outer lower tower segment is provided with connectors to connect the outer lower tower segment to an inner lower tower segment of another telescopic latticed tower segment assembly.

15. The tower crane according to claim 1, wherein the crane tower lifting unit is pivotally mounted to the crane base so as to be pivotal between a horizontal and a vertical orientation, and wherein a first upper segment is arranged in the crane tower lifting unit, and wherein the crane base and crane tower lifting unit mounted thereon with the first upper segment arranged therein form a first transportable assembly configured for road transportation, and wherein the slewable jib unit forms a second transportable assembly configured for road transportation.

16. The tower crane according to claim 15, wherein, with the first transportable assembly arranged at the hoisting site, the slewable jib unit is connectable to the upper segment whilst the crane tower lifting unit is oriented horizontally, wherein the interconnected crane tower lifting unit and slewable jib unit are then pivotal relative to the crane base into a vertical orientation of the lifting unit in an upending step.

17. The tower crane according to claim 1, wherein the slewable jib unit comprises:
a slew bearing mounted between a lower jib unit structure which is to be connected to the crane tower and an upper jib unit structure;
a jib which is pivotally mounted to the upper jib unit structure about a jib pivot axis;
a jib luffing mechanism configured to luff the jib; and
a winch and associated hoisting cable depending from a sheave assembly on the jib.

18.-25. (canceled)

26. A self-climbing tower crane which is configured to be arranged on a support at a hoisting site, wherein the tower crane comprises:
a crane base configured to be placed on the support at the hoisting site;
a crane tower to be erected on the crane base and to be composed of tower segments that are to be stacked one-by-one onto one another;
a crane tower lifting unit configured to perform a lifting action in the process of erecting the crane tower; and
a slewable jib unit configured to be mounted on top of the crane tower,
wherein the crane base, crane tower lifting unit, and slewable jib unit are configured to be combined to an assembly which is to be arranged at the hoisting site in an initiation state thereof, the assembly in said initiation state comprising:
the crane base placed on the support at the hoisting site;
the crane tower lifting unit pivotally mounted to the crane base and oriented horizontally; and
the slewable jib unit connected to the crane tower lifting unit and oriented horizontally,
wherein the interconnected crane tower lifting unit and slewable jib unit are pivotal relative to the crane base into a vertical orientation in an upending step, and
wherein the crane is configured to, with the interconnected crane tower lifting unit and slewable jib unit in said vertical orientation, erect the crane tower by stacking tower segments one-by-one onto one another to lengthen the crane tower under the jib unit, wherein the crane tower lifting unit is configured to perform a lifting action in association with the stacking of a tower segment.

27. The tower crane according to claim 26, wherein the assembly which is to be arranged at the hoisting site in an initiation state thereof further comprises a pivoting actuator mechanism that is configured to pivot the interconnected crane tower lifting unit and slewable jib unit into the vertical orientation in the upending step.

28. The tower crane according to claim 26, wherein the tower crane comprises:
a first road vehicle configured to transport the crane base and the crane tower lifting unit to the hoisting site, wherein the lifting unit is pivotally mounted to the crane base and is oriented horizontally on the first road vehicle; and
a second road vehicle configured to transport the slewable jib unit to the hoisting site, wherein the jib unit is oriented horizontally on the second road vehicle.

29. The tower crane according to claim 26, wherein a first road vehicle forms at least a part of the crane base, the first road vehicle having a trailer chassis which forms at least a part of the crane base.

30. The tower crane according to claim 26, wherein the slewable jib unit comprises:
a slew bearing mounted between a lower jib unit structure that is to be connected to the crane tower or the crane tower lifting unit and an upper jib unit structure;
a jib that is pivotally mounted to the upper jib unit structure about a jib pivot axis;
a jib luffing mechanism configured to luff the jib; and
a winch and associated hoisting cable depending from a sheave assembly on the jib.

31. (canceled)
